(19) United States
(12) Patent Application Publication
(10) Pub. No.: US 2024/0152610 A1
(43) Pub. Date: May 9, 2024

(54) METHODS AND SYSTEMS FOR DETECTING AND BLOCKING MALICIOUS ACTIONS IN OPERATING SYSTEM

(71) Applicant: ZeroPeril Ltd., Rugby Warwickshire (GB)

(72) Inventors: Thomas John Wilson, Warwickshire (GB); Kyriakos Economou, Warwickshire (GB)

(21) Appl. No.: 18/548,623

(22) PCT Filed: Feb. 25, 2022
(86) PCT No.: PCT/GB2022/050513

§ 371 Date: Sep. 1, 2023

(30) Foreign Application Priority Data
Mar. 3, 2021 (GB) 2103020.0

(51) Int. Cl. G06F 21/55; G06F 21/53

(52) U.S. Cl. CPC G06F 21/554; G06F 21/53

(57) ABSTRACT

Methods and systems for blocking and detecting exploits and malicious code in an operating system and preventing malicious actions from being taken within the Windows® Kernel and within user mode applications.

### TECHNICAL FIELD

Embodiments of the present invention described herein relate to methods and systems for detecting and blocking malicious actions being taken within the Windows® Kernel and within user mode applications.

### BACKGROUND TO THE INVENTION

A common attack vector for malicious actors are unpatched or unknown (zero-day) software bugs in user mode and kernel mode software. In 2019 alone there were twenty zero-day exploitable software bugs discovered by Google as being used by malicious actors. An exploit is software designed to take advantage of a flaw in a computer system, typically for malicious purposes. Kernel mode is execution within the Windows® Kernel CPU Ring 0. User mode is execution within an application CPU Ring 3.

With remote working being a running theme of 2020, researchers turned their attention to the Zoom video conferencing application. A serious flaw was found that would allow an attacker to execute code remotely on the victim's computer.

The question is, how many unknown exploitable software bugs are yet to be discovered?

US 2019/0325133 A1 is a system for detecting and mitigating elevation of privilege.

US 2011/239306 A1 is concerned with Data Leak Prevention.

US 2016/328561 A1 is concerned with detecting root kits and samples various hardware performance counters, as well as taking execution address samples over time. The distribution of address samples and other event information is fed into a neural-network or other machine learning system which has been trained on known good samples. This provides a ‘fingerprint’ value, and the deviation of this value from a baseline value is used to determine if the process is malware or legitimate.

US 2018/239657 A1 describes a system for bi-directional communication between the Windows® Kernel and user mode processes. The invention also includes the description of an API (symmetric bridge) which allows clients to call the same API from both Kernel mode and user mode, additionally the API is identical on other platforms.

### SUMMARY OF THE INVENTION

Embodiments of the present invention address the above problem, by providing methods and systems for blocking and detecting exploits and malicious code and preventing malicious actions from being taken within an operating system Kernel (such as, for example, the Microsoft® Windows® Kernel) and within user mode applications.

From a first aspect, embodiments of the present invention provide a computer implemented method for detecting and blocking malicious actions in a computer operating system. The method comprises: (i) recording a first status of operating system kernel data upon initiation of one or more operating system events; (ii) recording a second status of the operating system kernel data in response to a system call triggering the one or more defined operating system events; (iii) performing one or more security checks, the one or more security checks comprising comparing the first status to the second status; (iv) detecting any discrepancies between the first status and the second status; and (v) if a discrepancy is detected, taking appropriate action based on the discrepancy.

The first aspect is referred to as “ZEROPERIL Integrity Shield”. Integrity Shield checks the integrity of the original Windows® kernel data at various points during Windows® Kernel execution (in response to system calls) by making comparisons with a copy of the data and/or information about the initial state of that data (an entire copy of the data is not necessary, this allows memory resources to be used more effectively), discrepancies indicate that exploitation is taking place and the software can act accordingly. Additional state information beyond simply copying resources can be recorded, state information which can then be used to provide further checks for malicious behaviours with the Windows® Kernel. Integrity Shield prevents exploitation of the Windows® Security Model. For example, to exploit the Windows® Security Model, attackers may use bugs and design flaws within the operating system, drivers and third-party software to gain the ability to make modifications, so that the security checks made within the Windows® Kernel allow more interaction with a Securable Object than would ordinarily be granted. Integrity Shield either prevents and/or detects this.

In some embodiments, the operating system kernel data comprises one or more of the following:
(i) CPU control registers;
(ii) driver signature enforcement state;
(iii) process information; and/or
(iv) thread information.

In some embodiments, the one or more operating system events comprise one or more of the following:
(i) Kernel drivers being loaded
(ii) Process creation
(iii) Process termination
(iv) Thread creation
(v) Thread termination
(vi) Module/dynamic link library mapping for execution
(vii) Request to open or to duplicate an operating system handle to a process object
(viii) Request to open or to duplicate an operating system handle to a thread object
(ix) Request to open or to duplicate an operating system handle to a registry key
(x) Request to open or to duplicate an operating system handle to a file
(xi) Request to open or to duplicate an operating system handle to a directory
(xii) Request to open or to duplicate an operating system handle to a named pipe
(xiii) Request to open or to duplicate an operating system handle to a mail slot
(xiv) Request to open or to duplicate an operating system handle to a device object.

In some embodiments, the one or more security checks comprise one or more of the following:
(i) checking whether an administrator group Security Identifiers, SID, has been added to a process token;
(ii) checking whether a privilege has been added to a process token;
(iii) checking whether a Discretionary Access Control List, DACL, is present within a securable object;
(iv) checking whether a Security Descriptor, SD, is set to “NULL”;
(v) checking whether CPU control registers have been tampered with;
(vi) checking whether a driver signature enforcement state has been tampered with;
and/or
(vii) checking whether a Process Protection Light, PPL, status has been tampered with.

In some embodiments, the appropriate action comprises one or more of:
(i) notifying a user of the discrepancy;
(ii) quarantining operating system objects associated with the operating system event; and/or
(iii) terminating and/or blocking and/or deleting the operating system objects associated with the operating system event.

When a component of ZEROPERIL, such as Integrity Shield, Security Check Enforcement or User Mode Hook Shield detects that a process is the source of malicious behaviour the process may be terminated and/or the user may be notified. Some processes are critical to the stability of Windows® and cannot be terminated without adverse effects, for example the Isass.exe process is system critical and will result in a Windows® bug check if terminated. System critical process can instead be put into a quarantine state and the user notified. Optionally the ZEROPERIL user may turn the process termination option off, resulting in malicious processes being quarantined instead of terminated.

In some embodiments, quarantining the operating system objects comprises reducing granted privileges and/or prohibiting actions in response to the operating system event.

Quarantined process may be denied write, delete and rename access to file systems and may be denied the ability to connect to resources over the network which will be achieved by ZEROPERIL using the Windows® Filtering Platform API.

In some embodiments, reducing the privileges comprises prohibiting one or more of:
(i) creating a child process;
(ii) creating a thread within another process;
(iii) reading and/or writing memory within another process;
(iv) duplicating and/or accessing handles from another process;
(v) interrogating the security token of another process or thread;
(vi) suspending, resuming and/or terminating another process;
(vii) suspending, resuming and/or terminating a thread belonging to another process;
(viii) limiting registry access of the operating system objects;
(ix) limiting file system access of the operating system objects;
(x) limiting network access of the operating system objects; and/or
(xi) in response to a request to access an operating system object, a set of granted access permissions is modified to be a less privileged subset of a set of requested permissions.

From a second aspect, embodiments of the present invention provide a computer implemented method for detecting and blocking exploitation of kernel driver design flaws from being used for malicious actions in a computer operating system. The method comprises: (i) detecting where a kernel Input/Output request originates from; (ii) if the request originates from a kernel mode, performing a security check against a process performing the request, wherein the security check comprises checking whether the process is authorised to perform the request; and (iii) if the process is not authorised to perform the request, blocking the request.

The second aspect is referred to as “ZEROPERIL Security Control Enforcement”. This aspect protects against the exploitation of kernel driver design flaws from being used for malicious action. This aspect uses a unique approach to detect and block kernel Local Privilege Escalation (LPE) exploits that abuse design flaws in kernel drivers that may allow a low privilege user to perform unauthorised actions through a request to the affected driver.

In some embodiments, the security check is performed against the security descriptor of an object that the request is attempting to access.

In some embodiments, the security check is performed by calling a Kernel API function, such as a SeAccessCheck Kernel API function, a FltCreateFile Kernel API function, a FltCreateFileEx Kernel API function, or a FltCreateFileEx2 Kernel API function.

In some embodiments, the security check is performed by an Input/Output request to a file system MiniFilter driver within a filter driver stack.

In some embodiments, the performing the security check comprises duplicating the request such that the duplicate request enforces additional Kernel security checks.

From a third aspect, embodiments of the present invention provide a computer implemented method for detecting and blocking tampering within user mode portions of a security system. The method comprises: (i) creating a thread which periodically compares one or more first statuses of one or more memory locations within an application to one or more second statuses of the one or more memory locations within the application, each memory location having a corresponding first and second status; (ii) detecting, by the thread, any discrepancies between one or more corresponding first and second statuses; (iii) if a discrepancy is detected, taking appropriate action based on the discrepancy; and wherein the thread is protected from tampering.

The third aspect is referred to as “ZEROPERIL User Mode Shield”. This aspect detects tampering within the user mode portions of the ZEROPERIL security system, such as user mode hooks. This aspect is designed to detect techniques that tamper with its user mode hooks or other portions of user mode code that should not be modified, on detection of tampering action can then be taken, such as quarantining the process.

In some embodiments, an operating system thread is created that monitors for changes to the memory addresses where user mode hooks are placed within a process.

In some embodiments, the thread is created in each process that requires monitoring.

In some embodiments, the thread is protected from tampering by creating a kernel mode system thread to perform the checks instead of a thread in each process.

In some embodiments, the thread is protected from tampering by setting a Security Descriptor an appropriate Discretionary Access Control List, DACL, on the thread such that only a kernel has ‘write’ access to the thread.

In some embodiments, the thread is protected from tampering by blocking access to the thread from within a kernel callback.

In some embodiments, the thread is protected from tampering by placing a list of the one or more memory locations into a first memory page and optionally adding a PAGE GUARD flag onto the first memory page.

In some embodiments, the thread is protected from tampering by placing executable code of the thread into a second memory page.

In some embodiments, the first and second memory pages have a read only status and have protections such that the read only status cannot be changed.

In some embodiments, the thread is protected from tampering by using a mapping process, the mapping process comprising: firstly, mapping a file into a virtual address space of a process associated with the thread; secondly, storing the one or more memory locations in the file; and thirdly, unmapping the file. While the mapping process is being performed, access to the file is prohibited from anywhere except the thread. Further, the thread periodically comparing the one or more first statuses to the one or more second statuses comprises periodically performing the mapping process.

From a fourth aspect, embodiments of the present invention provide a computer implemented method for communication between a user mode and a kernel mode, the method comprising using a thread to communicate data to a kernel driver, wherein a thread entry point is offset from a known address within a running process in dependence on a value of the data, such that determining a distance from the thread entry point to the known address is used to calculate the value of the data.

The fourth aspect is known as “ZEROPERIL Immediate Response”. This aspect allows ZEROPERIL protection functionality within user mode applications, such as User Mode Shield, to immediately report tampering and other relevant data to the ZEROPERIL Windows® drivers. This aspect is complementary to the other aspects described above.

In some embodiments, the thread is marked as THREAD_PRIORITY_TIME_CRITICAL priority, such that the thread is scheduled to run as soon as possible.

From a fifth aspect, embodiments of the present invention provide a system comprising:
a processor; and
a memory including computer program code;
   the memory and the computer program code configured to, with the processor, perform a method according to of any of the above embodiments.

From a sixth aspect, embodiments of the present invention provide a computer readable storage medium storing one or more computer modules arranged such that, when executed by a processor, a computer system operates in accordance with the method of any of the above embodiments.

### BRIEF DESCRIPTION OF THE DRAWINGS

Embodiments of the invention will now be further described by way of example only and with reference to the accompanying drawings, wherein:

FIG. 1 illustrates process or thread interaction with Windows® Securable Object, without the present invention;

FIGS. 2A and B illustrate Integrity Shield ProcessLogEntry and ThreadLogEntry structures, embodiments of the present invention;

FIG. 3 illustrates a kernel exploit replacing a token pointer with a token pointer that has administrative credentials, without the present invention;

FIGS. 4A and B illustrate a Kernel exploit replacing a token pointer with a token pointer that has administrative credentials, intercepted by embodiments of the present invention, the process is quarantined and the user informed;

FIG. 5 illustrates a Kernel exploit adding additional privileges to a token, without the present invention;

FIGS. 6A and B illustrate a Kernel exploit adding additional privileges to a token, being intercepted by embodiments of the present invention, and quarantined;

FIG. 7 illustrates an elevated process being created with a NULL DACL, and a malicious process taking advantage of this security flaw, without the present invention;

FIG. 8 illustrates an elevated process being created with a NULL DACL, a malicious process trying to take advantage of this security flaw, but being detected by embodiments of the present invention and generating an alert;

FIG. 9 illustrates a Kernel exploit setting a Security Descriptor pointer to NULL in the_OBJECT_HEADER, this allows unrestricted access to the object, without the present invention;

FIG. 10 illustrates a Kernel exploit setting a Security Descriptor pointer to NULL in the_OBJECT_HEADER, embodiments of the present invention detect this and quarantine the malicious process;

FIG. 11 illustrates a Kernel exploit tampering with CPU control registers in order to disable Supervisor Mode Execution Prevention (SMEP) for example, to facilitate completion of a kernel mode exploit, without the present invention;

FIG. 12 illustrates a Kernel exploit tampering with CPU control registers in order to disable SMEP for example, to facilitate completion of a kernel mode exploit.

Embodiments of the present invention detect the modification, restore the CPU registers and alert the user;

FIG. 13 illustrates a Kernel mode exploit tampering with Driver Signature Enforcement flags within the Kernel in order to load a rootkit driver, without the present invention;

FIG. 14 illustrates a Kernel mode exploit tampering with Driver Signature Enforcement flags within the Kernel in order to load a rootkit driver. Embodiments of the present invention detect the modification, prevent the driver from loading and alert the user;

FIG. 15 illustrates the “Process Protected Light” (PPL) status of a process being modified by a Kernel exploit, without the present invention;

FIG. 16 illustrates the PPL status of a process being modified by a Kernel exploit. Embodiments of the present invention detect the modification and quarantine the process and alert the user;

FIG. 17 illustrates Kernel mode exploitation without the present invention known as Security Control Enforcement (SCE);

FIG. 18 illustrates Kernel mode exploitation with embodiments of the present invention, SCE;

FIG. 19 is a flow chart illustrating User Mode Shield according to some embodiments of the present invention;

FIG. 20 is a flow chart illustrating an Immediate Response thread according to some embodiments of the present invention;

FIG. 21 shows x64 Immediate Response thread stubs, which may or may not be padded to an arbitrary byte boundary, for example, an 8 byte boundary, or any other suitable number of bytes padding, in accordance with some embodiments of the present invention;

FIG. 22 shows x86 Immediate Response thread stubs, which may be padded to an 8 byte boundary, or any other suitable number of bytes padding, in accordance with some embodiments of the present invention; and

FIG. 23 is a block diagram of a system according to some embodiments of the present invention.

### DESCRIPTION OF THE EMBODIMENTS

### 1. Overview

Embodiments of the present invention, referred to herein as “ZEROPERIL” comprise operating system (such as, e.g. Microsoft® Windows®) software consisting of several components working together in both kernel mode and user mode. ZEROPERIL blocks and detects exploits and malicious code and prevents malicious actions being taken within the operating system Kernel and within user mode applications.

The engine consists of four main components. The four main components are referred to herein as “Integrity Shield”, “Security Control Enforcement”, “User Mode Shield” and “Immediate Response”.

ZEROPERIL Integrity Shield uses a unique approach whereby a copy is taken of the data within and/or information is stored on the initial state of (an entire copy of the data is not necessary, this allows memory resources to be used more effectively) commonly and not so commonly exploited Windows® Kernel data structures. The copy and/or information is placed into a custom storage location, which may be, for example, a memory, or a HDD database or sent over the network to a server. It is then possible to check the integrity of the original Windows® Kernel data at various points during Windows® Kernel execution by making comparisons with the copy of the data and/or querying kernel the data structures and comparing the initial information with the latest information, discrepancies indicate that exploitation is taking place and the software can act accordingly. Additional state information beyond simply copying resources may also be recorded, state information which can then be used to provide further checks for malicious behaviours with the Windows® Kernel. By recording state information which can be used to provide checks for malicious behaviours with the Windows® Kernel rather than simply copying resources, memory resources are used more efficiently. For example, copying an entire ACCESS_TOKEN structure occupies over 1 kilobyte of data, whereas only 40 bytes of data is required to store a “ProcessLogEntry” which includes security information above and beyond that which can be obtained from an ACCESS_TOKEN.

ZEROPERIL Security Control Enforcement protects against the exploitation of kernel driver design flaws from being used for malicious action.

ZEROPERIL User Mode Shield detects tampering within the user mode portions of the ZEROPERIL security system, such as user mode hooks.

ZEROPERIL Immediate Response allows ZEROPERIL protection functionality within user mode applications, such as User Mode Shield, to immediately report tampering and other relevant data to the ZEROPERIL Windows® drivers.

2. Applications

ZEROPERIL has a number of possible applications, including but not limited to exploit and malware detection and prevention, anti-cheat or cheating prevention and prevention of circumvention of software license checks.

2.1. Exploit and Malware Detection and Prevention

ZEROPERIL is applicable to the area of kernel mode and user mode exploit prevention.

ZEROPERIL Integrity Shield and Security Control Enforcement protect the Microsoft® Windows® operating system from such attacks referred to in the background section. This may be combined with user mode hooking which can be used in a variety of ways to detect malicious behaviour within user mode processes. The ZEROPERIL user mode hooks can be protected using the ZEROPERIL User Mode Shield, notification of issues detected by user mode hooks for example tampering or behavioural alerts can be immediately sent to the ZEROPERIL drivers using ZEROPERIL Immediate Response.

2.2. Anti-Cheat

Anti-Cheat software is often used to detect game hacks and cheaters in online multiplayer games. The idea behind anti-cheat is to prevent malicious code from altering a running game's data in memory, for example loading code into the address space of the game which alters the display code to highlight adversaries who are behind walls. It can be seen that the technology provided by ZEROPERIL for defeating zero-day exploits, and exploitation of software bugs is also applicable in the field of anti-cheat, where it is desired to detect tampering in both user mode and kernel mode.

2.3. Prevention of Circumvention of Software License Checks

Software licensing bypassing, known as “cracking” in the most trivial cases usually involves locating the code that performs a license check, and inserting executable code instructions to ensure that the check passes regardless of the license status. In the case of license checking code ZEROPERIL User Mode Shield has an application in detecting tampering with such code.

Various aspects and details of these principal components will be described below with reference to the figures.

3. Integrity Shield

3.1. Problem: Microsoft® Windows® Access Control Exploitation

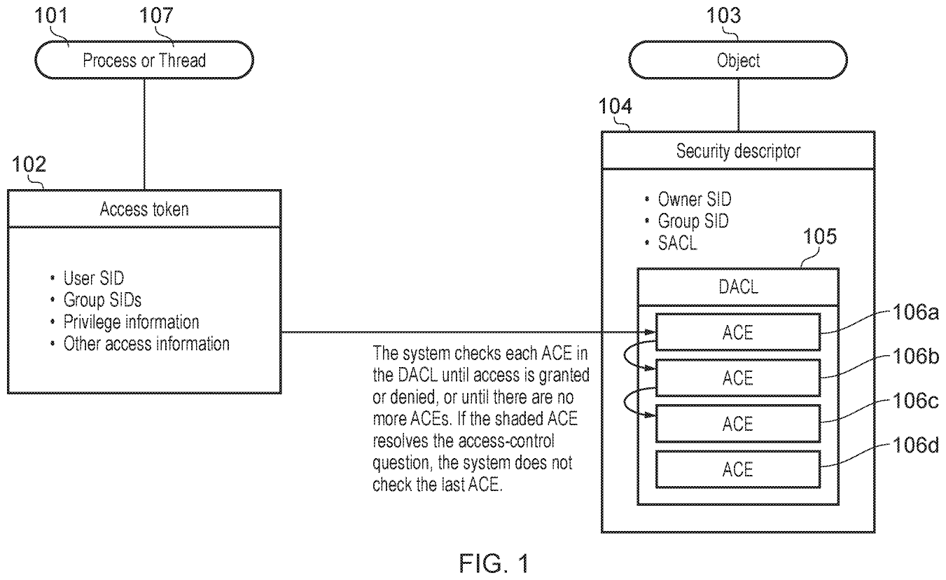

By way of example and as illustrated in FIG. 1, without ZEROPERIL available, when a Windows® Kernel securable object 103 is created, (for example a thread 107, or process 101) the Windows® Kernel stores information about the object inside various data structures. Parts of this information are subsequently used to control access to the object.

As illustrated in FIG. 1, two main data structures are used when controlling access within the Windows® Kernel; the Security Descriptor (SD) 104, and contained within the Security Descriptor a Discretionary Access Control List (DACL) 105.

All securable Windows® Kernel objects 103 have a pointer to a SD 104 that contains the DACL 105 associated with the kernel object 103.

In summary, a DACL 105 is essentially a list of Security Identifiers (SID). Each entry inside the DACL 105 is called “Discretionary Access Control Entry” (ACE) 106a, 106b, 106c, 106d and contains the information about the level of access that a SID has towards the target Windows® Kernel object 104.

Every process 101 running within the Windows® Operating System has an Access Token object 102 associated with it, optionally individual threads 107 belonging to a process 101 may also have an Access Token 102. When a process 101 or a thread 107 interacts with a securable object 103, checks are performed with in the Windows® kernel to determine if the interaction is permitted. The system checks each ACE 106a, 106b, 106c, 106d until access is granted or denied, or until there are no more ACEs. For example, if ACE 106c resolves the access-control question, the system does not check ACE 106d. As shown in FIG. 1, the Access Token 102 may comprise one or more of a user SID, a group SID, privilege information and/or other access information. The SD 104 may comprise one or more of an owner SID, a group SID, a system access control list (SACL), and a DACL 105.

To exploit the Windows® Security Model, attackers will use bugs and design flaws within the operating system, drivers and third-party software to gain the ability to make modifications to the SD 104, DACL 105, ACEs 106a, 106b, 106c, 106d so that the security checks made within the Windows® Kernel allow more interaction with a Securable Object 103 than would ordinarily be granted. Windows® Kernel exploitation is not limited to modification of these structures; however, this serves as an illustration of one area in particular that Integrity Shield will protect.

3.2. Solution: ZEROPERIL Integrity Shield

The ZEROPERIL Integrity Shield system may create copies of relevant Windows® kernel data structures (e.g. 104, 105) and objects (e.g. 103) and record relevant security information using well documented functionality available within the Windows® Kernel API.

Additionally or alternatively, the ZEROPERIL Integrity Shield system may record initial information about Windows® kernel data structures (e.g. 104, 105) and objects (e.g. 103) using well documented functionality available within the Windows® Kernel API. As mentioned above, this option is advantageous as it requires much less data storage and therefore uses memory more effectively due to not having to copy the entire structure. By recording specific information about structures, rather than the entire structures themselves, more security information can be recorded whilst using much less memory.

3.3. ZEROPERIL Integrity Shield Details

ZEROPERIL makes use of a series of Windows® Kernel Drivers, and functionality available within the Windows® Kernel API for installing software callbacks. A callback is a software mechanism whereby interest in an event is registered and a subject function is provided that will be called when the event is triggered. ZEROPERIL registers callbacks to intercept one or more of the following events:
(i) Kernel drivers being loaded
(ii) Process creation
(iii) Process termination
(iv) Thread creation
(v) Thread termination
(vi) Module/dynamic link library mapping for execution
(vii) Request to open or to duplicate an operating system handle to a process object
(viii) Request to open or to duplicate an operating system handle to a thread object
(ix) Request to open or to duplicate an operating system handle to a registry key
(x) Request to open or to duplicate an operating system handle to a file
(xi) Request to open or to duplicate an operating system handle to a directory
(xii) Request to open or to duplicate an operating system handle to a named pipe
(xiii) Request to open or to duplicate an operating system handle to a mail slot
(xiv) Request to open or to duplicate an operating system handle to a device object.

Within the Integrity Shield Kernel drivers at the interception points described above, a record is taken of initial security information and/or copies are taken of Windows® Kernel data. The initial security information and/or copies are relevant to the prevention of exploitation, malicious use and/or to the security of the system.

Security checks are performed by Integrity Shield during calls to the interception points described above, and appropriate action is taken based on any changes made to Windows® Kernel data that is seen to be modified and/or comparison between initial information and current information. Refer to section 3.3.3 for details of the specific checks undertaken.

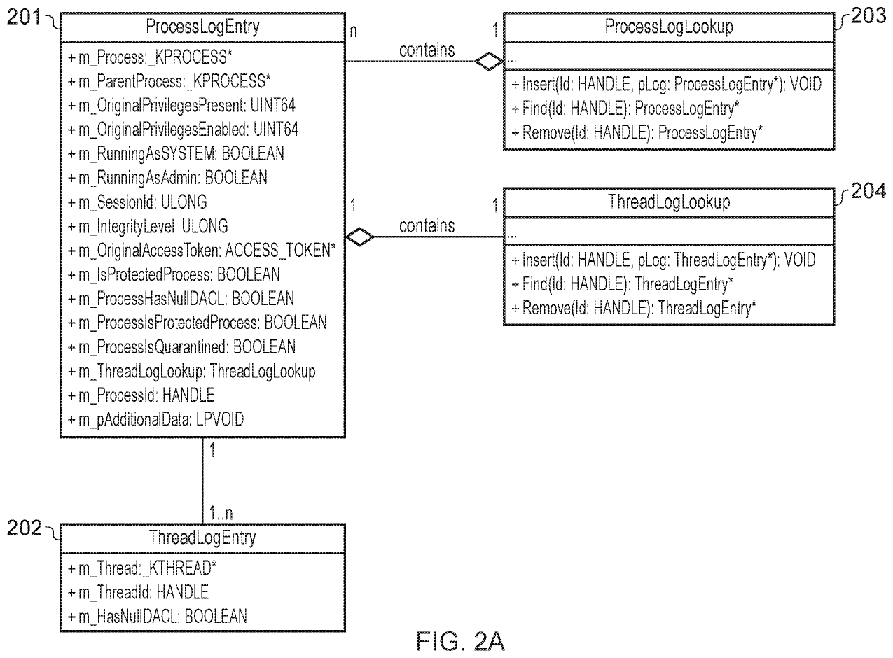

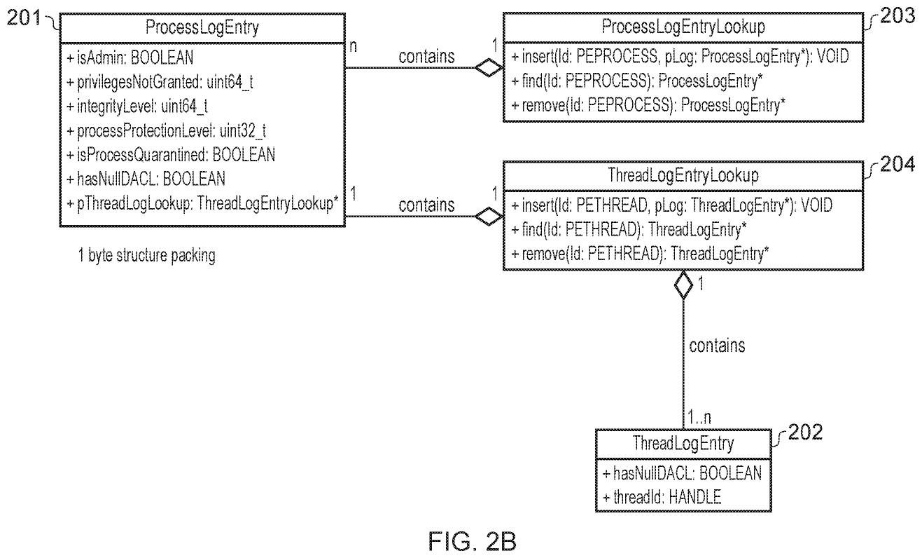

One or more of the following Windows® Kernel data may be copied and/or one or more of the following information may be stored by Integrity Shield:
Initial values of CPU control registers CR0, CR4
Kernel-mode exploits often tamper with CR0 and CR4 registers in order to temporarily/permanently disable certain security features during the exploitation stages.
Driver signature enforcement state
A value stored in the Windows® Kernel which indicates if driver signature enforcement is enabled or disabled.
Process information
Information relevant to each user mode process on the machine, see below for more details.
Thread information
Information on threads associated with each process, see below for more details.

Where processes and threads are concerned, there can be hundreds or thousands of instances to track. As illustrated in FIG. 2, FIGS. 2A and 2B are two possible examples, Integrity Shield takes the approach of structuring the data; storing it in a number of custom structures “ProcessLogEntry” 201 and “ThreadLogEntry” 202 in Kernel memory within a fast lookup table “ProcessLogEntryLookup” 203, 204 such as an AVL Tree, Binary Tree or in an ordered array combined with a binary search (generally any data structure with a better than O(n) search speed) indexed using the Windows® PEPROCESS pointer for each process.

Note that it may also be possible to store this ProcessLogEntry information 201 in a persistent storage location, either on a Hard Disk Drive HDD, or on the internet/network however network storage may prove too slow for Kernel Operations.

One possible optimisation for both disc and memory storage of the ProcessLogEntry data 201 would be to have a cache in memory for example a Least Recently Used (LRU) cache.

One or more of the following information may be recorded and/or copied for each process, during process creation:
A pointer to the Windows® Kernel_KPROCESS structure—an opaque Windows® Kernel data structure containing process information
Original token privileges present
Original token privileges enabled
If the process is running under the SYSTEM account
If the process is running under the Administrators group
The session to which the process belongs
The integrity level of the process
The original access token of the process—an opaque Windows® Kernel data structure containing access information
The Windows® Protected Process state
If the process had a NULL DACL originally
The parent process id
The process id
A pointer to additional data relevant to other ZEROPERIL features

Additionally or alternatively, one or more of the following information may be stored for each process, during process creation, which is obtained by calling the Windows® Kernel API function “SeQueryInformationToken”:
A flag value (true/false) indicating if the process has Administrative privilege
A bit mask containing a bit flag (0/1) for each privilege NOT granted to the process upon process initialisation. (This can be used in a logical AND operation to detect if new privileges have been maliciously granted to a process)
Original process integrity level.

Additionally, the following information may be stored for each process, during process creation:
The Windows® Protected Process state, which is obtained by calling “PsGetProcessProtection”
A flag indicating if the process had a NULL DACL originally, determined by calling “ZwQuerySecurityObject”, if the function returns NULL the SD is NULL and thus the DACL is NULL, otherwise the “Control” member is queried for SE_DACL_PRESENT.

One or more of the following information may be stored for each thread during thread creation:
A flag indicating if the thread had a NULL DACL originally by calling “ZwQuerySecurityObject” if the function returns NULL the SD is NULL and thus the DACL is NULL, otherwise the “Control” member is queried for SE_DACL_PRESENT.
The id of the thread
A pointer to the Windows® Kernel_KTHREAD structure—an opaque Windows® Kernel data structure containing thread information

For example, in order to determine if the process is running with Administrative privilege the Windows® Kernel function “SeTokenIsAdmin” can be called which returns a BOOLEAN flag value indicating the Administrative privilege status of a process token.

3.3.1. ZEROPERIL Kernel Driver Process Callback

During the process callback, if the callback indicates a process create operation is taking place, Integrity shield performs additional security checks (see section 3.3.3) and if the checks pass, the process creation is allowed, otherwise process creation is denied, the calling process may be quarantined and/or an action may be taken that alerts the user to a security issue.

If the process-create security checks have passed (section 3.3.3) Integrity Shield then creates a new data structure for the newly created process, the ProcessLogEntry 201.

The new ProcessLogEntry 201 is then added to a driver global lookup table so that it may be easily retrieved in the future, as shown in FIG. 2.

During the process callback, if the callback indicates a process terminate operation is taking place ProcessLogEntry 201 data structures are released and removed from the lookup table, any ThreadLogEntry 202 objects associated with the terminating process are also released.

3.3.2. ZEROPERIL Kernel Driver Thread Callback

During the thread callback if thread creation is indicated, Integrity Shield performs additional security checks (see section 4.2.3). If the checks pass, then a new ThreadLogEntry 202 structure is allocated and added to its respective ProcessLogEntry 201, otherwise thread creation is denied, the calling process is quarantined, or an action is taken that alerts the user to a security issue.

During the thread callback, if the callback indicates that thread termination is taking place the relevant ThreadLogEntry 202 data structure is released and removed from the corresponding ProcessLogEntry 201.

3.3.3. ZEROPERIL Integrity Shield: Security Checks

The following security checks take place as part of Integrity Shield.

Check: Detection of Illegal Administrator Group SID Addition to Process Token

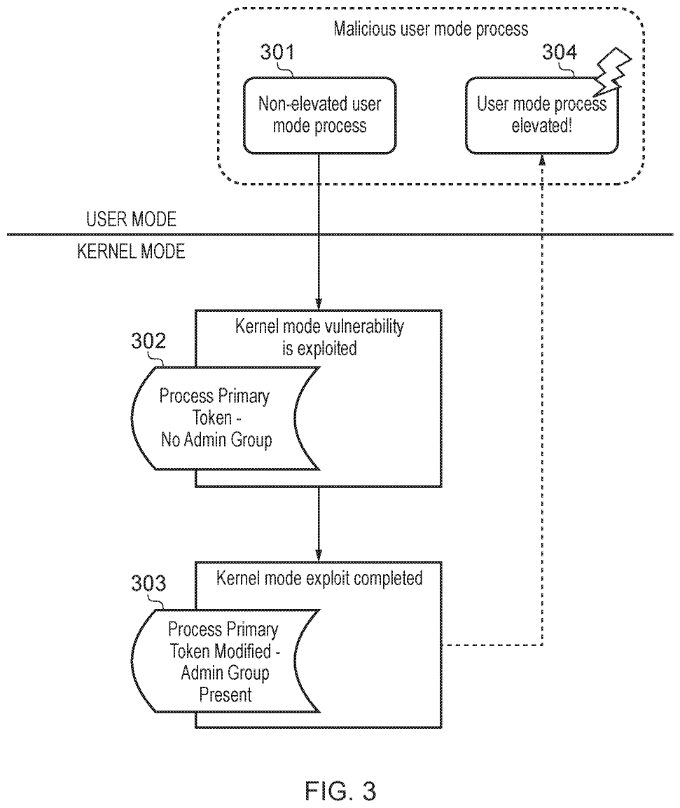

An attacker taking advantage of a software bug, or incorrectly designed driver may be able to obtain write access to kernel data structure, specifically the process token 302 within the Windows® kernel_EPROCESS structure. This attack is illustrated in FIG. 3. The attacker modifies a non-elevated user mode process 301 to be an elevated user mode process 304.

The attack works by modifying the pointer to point to a different token 303 that has Administrative credentials (rather than the original token 302 which does not have Administrative credentials) in order to give a malicious process more access than it would normally have. This is a common kernel mode exploitation scenario.

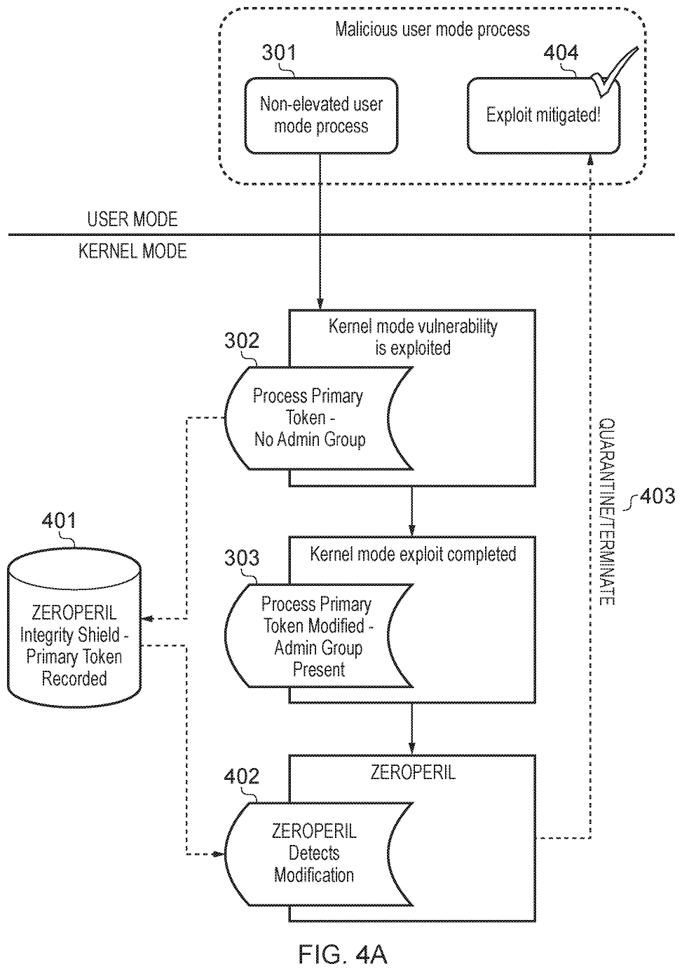

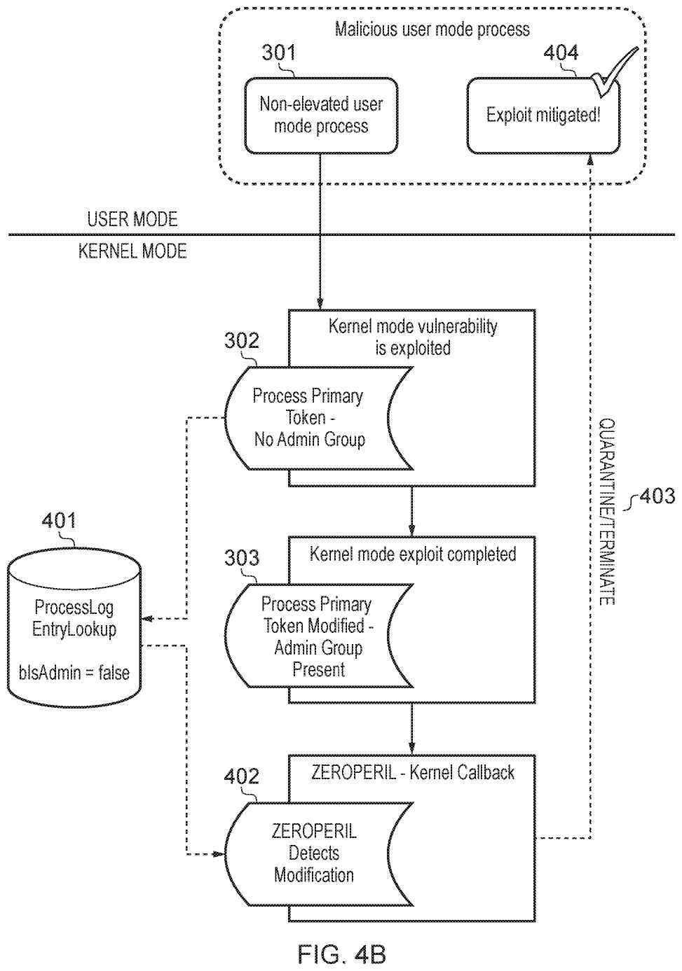

As illustrated in FIG. 4, FIGS. 4A and 4B are two possible examples, to stop this kind of attack, ZEROPERIL 401 records if a process object was created without the Administrator group SID in its token 302. The information is recorded into the ProcessLogEntry 201 upon process creation. The Windows® Kernel API function “SeTokenIsAdmin” is used to determine if the token has the Administrator group SID.

During callback operations and filtering operations within the Integrity Shield drivers the Kernel API function “SeTokenIsAdmin” is called for the current process token which returns a boolean flag value 303 this information is then compared 402 with the information contained in the corresponding ProcessLogEntry 201.

If the “SeTokenIsAdmin” returns true and the initial state was false, this indicates that the Administrator SID has been added to the process token 303 the process is either quarantined or terminated 403. Refer to section 7 for more information on process quarantine. The exploit is therefore mitigated 404. ZEROPERIL may alternatively or additionally send an alert to the user.

Check: Detection of Illegal Privilege Addition in Process Token

An attacker taking advantage of a software bug, or incorrectly designed driver may be able to obtain write access to kernel data structure, specifically the process token within the Windows® kernel_EPROCESS structure.

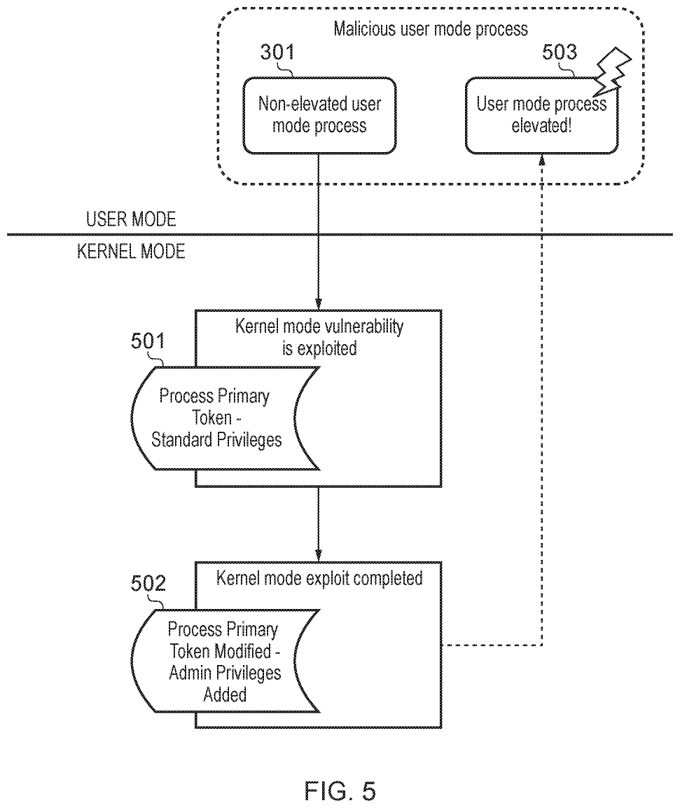

Adding new privileges to the token is a common kernel mode exploitation scenario and is illustrated in FIG. 5. A non-elevated user mode process 301 has a token 501 with standard privileges. An attacker may add admin privileges to the token to produce a modified token 502. The user mode process 503 is therefore elevated.

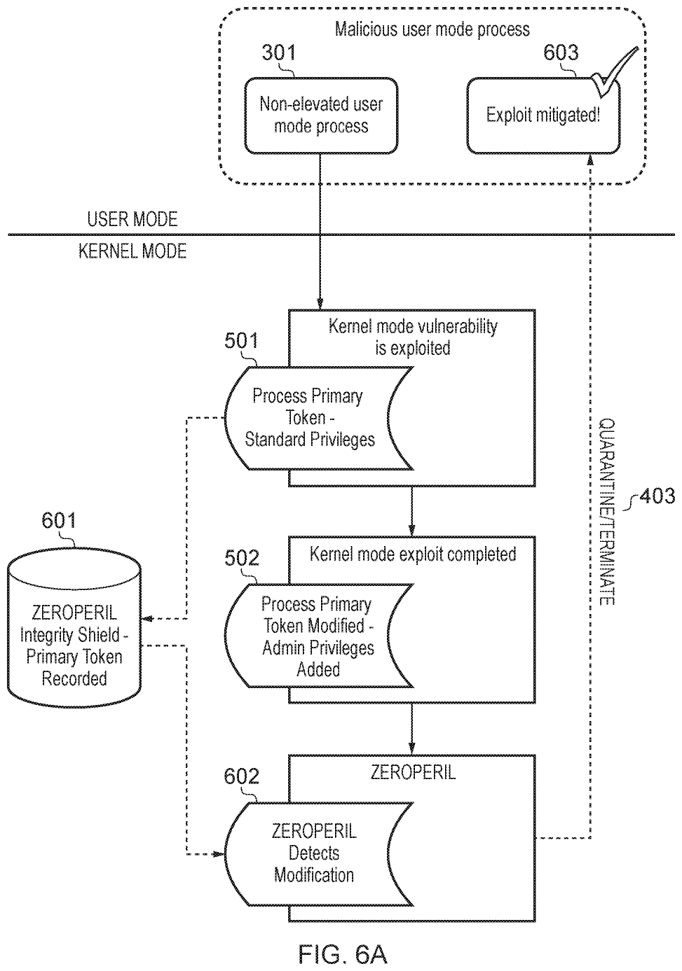

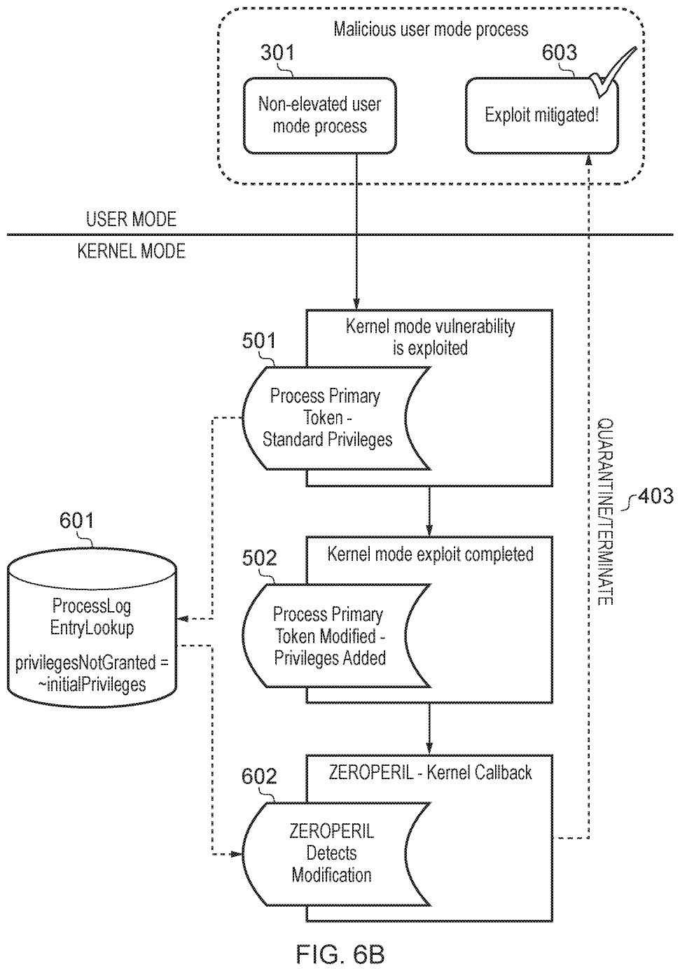

As illustrated in FIG. 6, FIGS. 6A and 6B are two possible examples, to stop this kind of attack, ZEROPERIL 601 records the token privileges that are not initially granted 501 into a ProcessLogEntry 201 on process creation.

During callback operations and filtering operations within the Integrity Shield drivers the current process token 502 is examined and the current privileges bit mask is taken. A logical and operation is performed with the stored bitmask of privileges not initially granted, stored in the ProcessLogEntry. If additional privileges have been maliciously granted the result of the logical operation is a value greater than zero. Additionally, the enabled privileges are verified using a logical and operation in the same way.

The privilege values are obtained from the token by calling the Windows® Kernel API function “SeQueryInformationToken” with the “TokenPrivileges” token information class and a bitmask is then created by examining the contents of the resulting “TOKEN PRIVILEGES” data structure.

In case an unauthorized modification is detected 602 in the process token the process may be either quarantined or terminated 403. Refer to section 7 for more information on process quarantine. Integrity Shield may also remove the additional privileges, resetting the process privileges back to the initial state, thus eliminating the threat 603. ZEROPERIL may alternatively or additionally send an alert to the user.

In this way, Integrity Shield protects the host from kernel mode Local Privilege Escalation (LPE) exploits that abuse those members in order to elevate the privileges of a low-level process and compromise further the affected host. Local privilege escalation is an exploitation method that allows the subject to obtain broader security privileges that would ordinarily be allowed.

Check: Detection of Protected Object DACL not Present

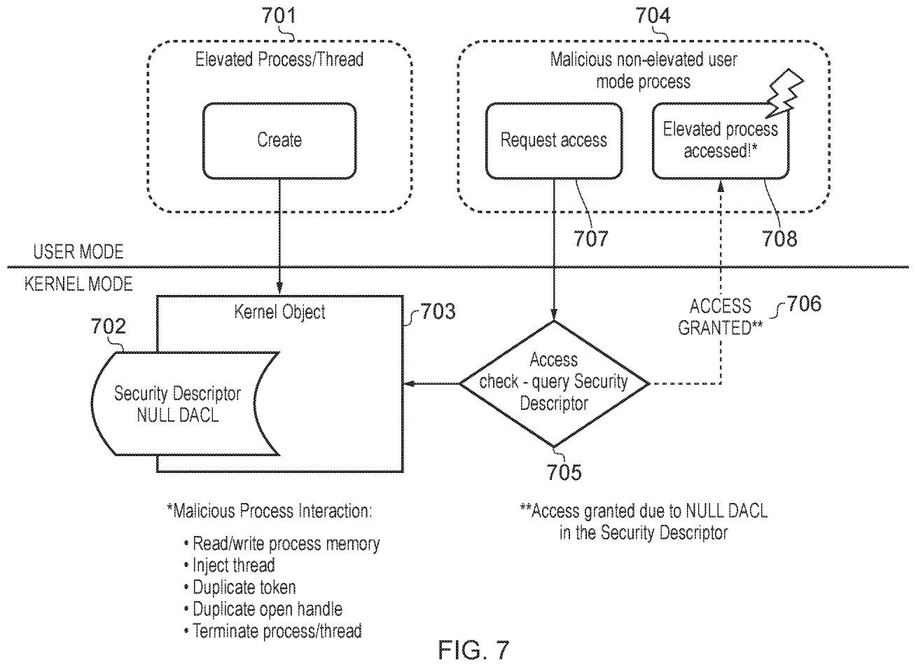

As illustrated in FIG. 7, an attacker taking advantage of a software bug, or incorrectly designed driver may be able to obtain write access to kernel data structure, specifically the Discretionary Access Control List (DACL) 702 within a securable object 703 in the Windows® Kernel. This gives access to an elevated process/thread 701, which should not be accessible.

Within the Security Descriptor (SD) structure 702 there is a Control flag member which indicates the presence of a DACL within the SD 702. An attacker may alter this flag indicating that no DACL is present, thus allowing everyone access to the securable object 703 and therefore the elevated process 701. This is a common kernel mode exploitation scenario. A malicious non-elevated user mode process 704 requests access 707 to the elevated process 701. An access check 705 queries the SD 702. Ordinarily, access would be denied as the SD 702 should be set to a non-NULL value and a DACL should be present. However, if an attacker has modified the SD to be set to NULL DACL, the access check 705 grants access 706 and the elevated process is accessed 708. This may allow the attacker to do one or more of the following: read/write process memory, inject the thread, duplicate the token, duplicate the open handle, and/or terminate the process/thread.

To stop this kind of attack, ZEROPERIL records a state flag to indicate if the DACL is currently present for the process 701 into a ProcessLogEntry 201 on process 701 creation. Or in the case of Thread creation, ZEROPERIL records a state flag to indicate if the thread DACL is currently present during thread creation and places the information into a ThreadLogEntry 202.

During callback operations and filtering operations within the Integrity Shield drivers the current process or thread SD Control member 702 is examined to see if it indicates that the DACL is not present, this is compared with the state flag recorded in the ProcessLogEntry 201 or ThreadLogEntry 202 which indicates the original DACL presence.

In the case where Integrity Shield detects that the SD Control member 702 has been modified to now indicate the DACL is not present, the process 701 may be quarantined or terminated. ZEROPERIL may alternatively or additionally send an alert to the user. Refer to section 7 for more information on process quarantine.

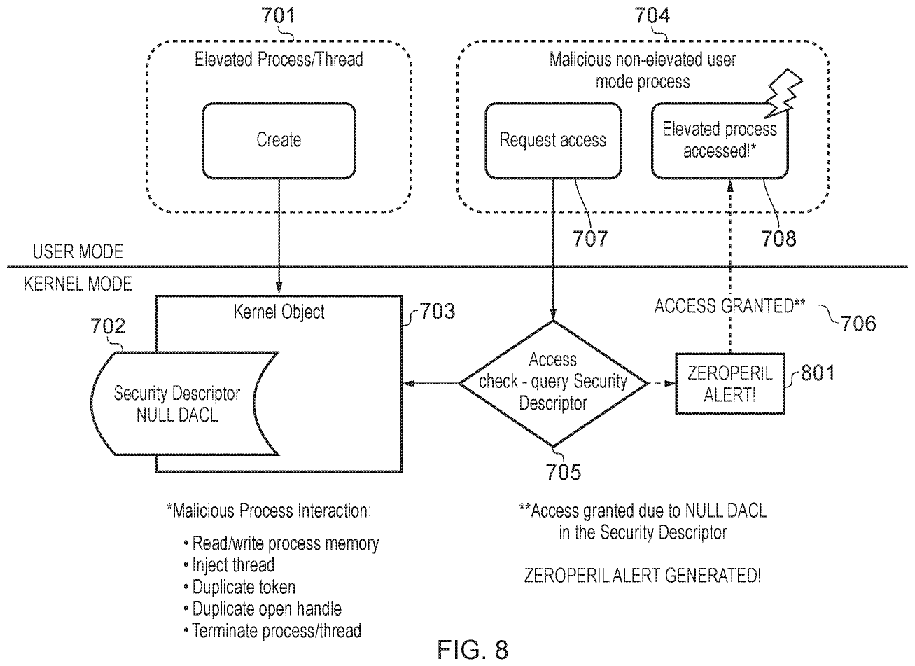

As illustrated in FIG. 8, a process or thread 701 starting without a DACL present in the SD 702 is potential security risk in itself, as it allows any user access to the process or thread 701, essentially meaning that there is no security on the object. ZEROPERIL will warn 801 the user of a potential security risk in this situation.

Check: Detection of Protected Object SD Set to NULL

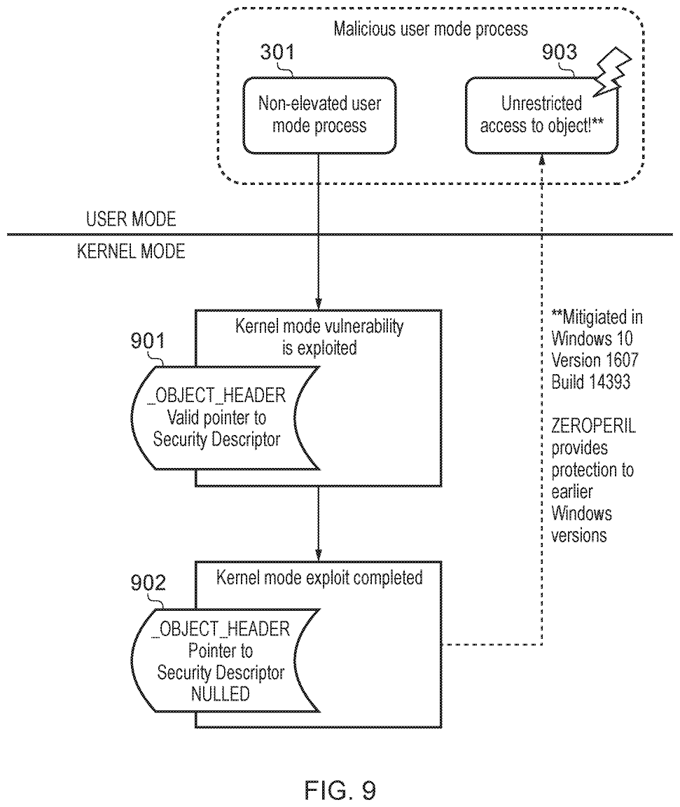

As illustrated in FIG. 9, an attacker taking advantage of a software bug, or incorrectly designed driver may be able to obtain write access to kernel data structure, specifically the Security Descriptor (SD) pointer within the_OBJECT_HEADER structure 901, which is present for all securable object in the Windows® Kernel.

Setting the SD pointer to NULL 902 within the_OBJECT_HEADER will allow everyone access 903 to the securable object, this is a common kernel mode exploitation scenario.

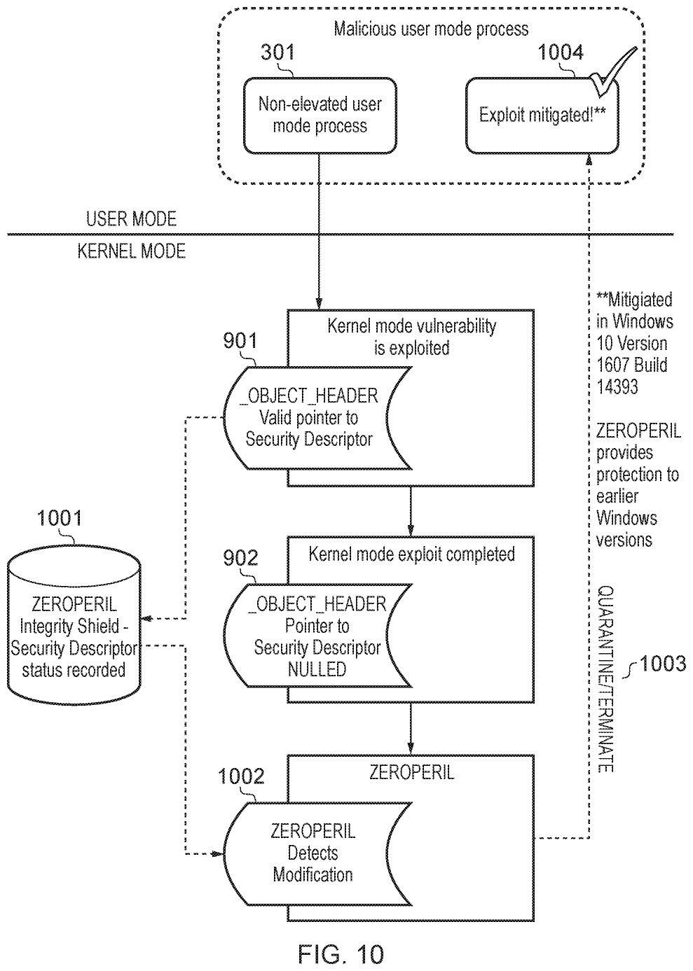

As illustrated in FIG. 10, to stop this kind of attack, ZEROPERIL 1001 records if the Security Descriptor (SD) 901 of a process 301 is NULL when the process is created, into a ProcessLogEntry 201. Or in the case of Thread creation, ZEROPERIL records if the thread SD is currently NULL during thread creation and places the information into a ThreadLogEntry 202.

During callback operations and filtering operations within the Integrity Shield drivers the current process or thread SD 902 is examined and compared with the copy in the ProcessLogEntry 201 or ThreadLogEntry 202 to see if the original SD pointer 901 has been set to NULL (zero), when the status of the original value recorded in the ProcessLogEntry 201 or ThreadLogEntry 202 was indicating not NULL.

In the case where Integrity Shield detects that the SD 902 has been set to NULL, the process 301 is either quarantined or terminated 1003. Refer to section 7 for more information on process quarantine. The exploit is therefore mitigated 1004. ZEROPERIL may alternatively or additionally send an alert to the user.

Note: This type of exploitation was mitigated by Microsoft® in Windows10 v1607 but the fix has not been back ported to previous versions of Windows. ZEROPERIL will protect all previous versions against this type of attack.

Check: Detection of Tampering with CPU Control Registers

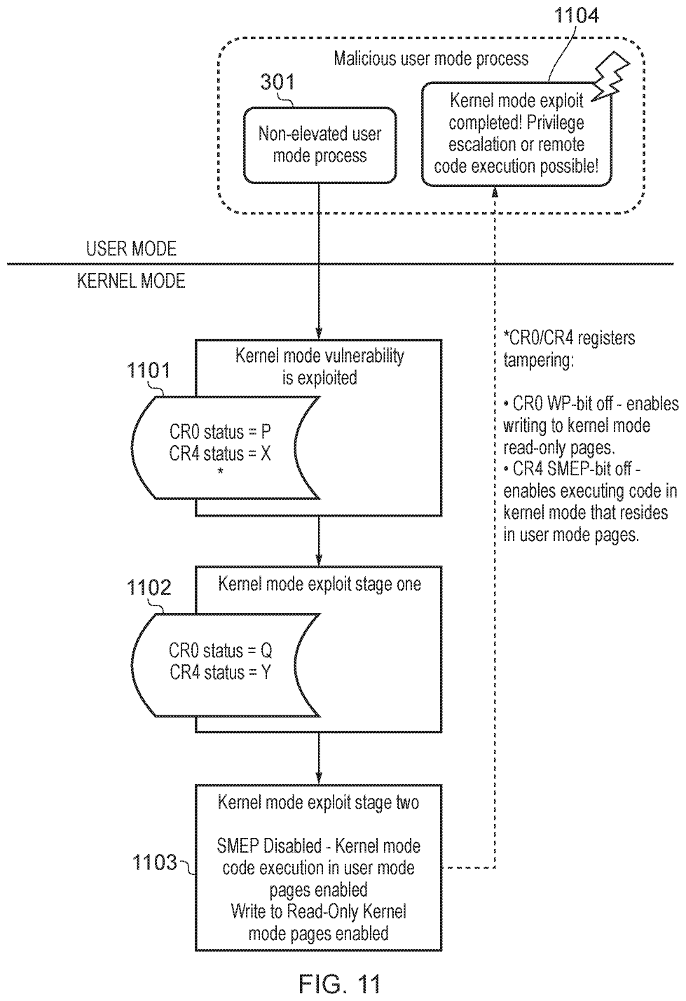

FIG. 11 illustrates a kernel exploit tampering with CPU control registers 1101, 1102 in order to disable Supervisor Mode Execution Prevention (SMEP) 1103 for example, to facilitate completion of a kernel mode exploit 1104. In FIG. 11, the original CPU control registers 1101 are: CR0 status=P and CR4 status=X. Stage one of an attacker's exploit is to modify the control register 1102 such that: CR0 status=Q and CR4 status=Y. Stage two of the attacker's exploit 1103 is to: (a) disable SMEP—this enables kernel mode code execution in user mode pages; and (b) enable write to read-only kernel mode pages. This completes the kernel mode exploit 1104. Privilege escalation or remote code execution is now possible.

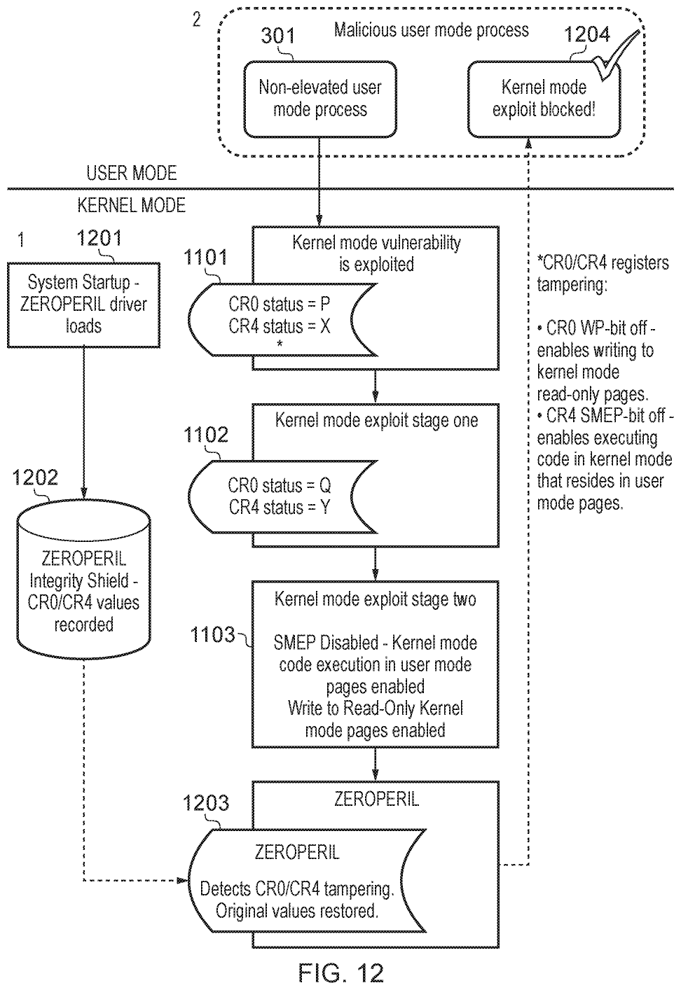

As illustrated in FIG. 12, the ZEROPERIL driver loads on system start up 1201. ZEROPERIL Integrity Shield 1202 copies the initial state of CPU Control Registers 1101 that contain flags which control CPU security features. Specifically, CR0 and CR4 control registers 1101 are monitored. Kernel mode exploits often tamper with these registers 1101 in order to temporarily/permanently disable certain security features during exploitation 1102, 1103.

In order to prevent such attacks, some operating systems check, at regular intervals for modifications to the CPU control registers 1101, for example, 64-bit builds of Microsoft® Windows® Kernel Patch Protection (KPP), also known as Patch Guard, checks the CPU control registers at random intervals for modification.

Since the checks do not happen in real-time, kernel mode exploits are often able to temporarily modify those registers, perform a malicious action, and then quickly restore the values, in-between randomised checks, thus going undetected.

Microsoft Windows® 8 introduced support for Supervisor Mode Execution Prevention (SMEP), which blocks executing code that resides in user mode memory pages while the CPU executes code in kernel mode. Advanced kernel mode exploits often temporarily disable SMEP 1103 by tampering with flag values held in the CR4 register.

During callback operations and filtering operations within the Integrity Shield drivers, Integrity Shield performs additional checks 1202, 1203 on the CPU control registers 1101, 1102. If tampering is detected 1203, then the original value 1101 is restored in order to block the attack 1204 before it gets a chance to complete successfully. The user may also be alerted.

Check: Detection of Tampering with Driver Signature Enforcement Setting

Driver Signature Enforcement (DSE) is built-in to 64-bit Microsoft® Windows® and ensures that only kernel drivers cryptographically signed by Microsoft® are allowed to be loaded into the Windows® Kernel.

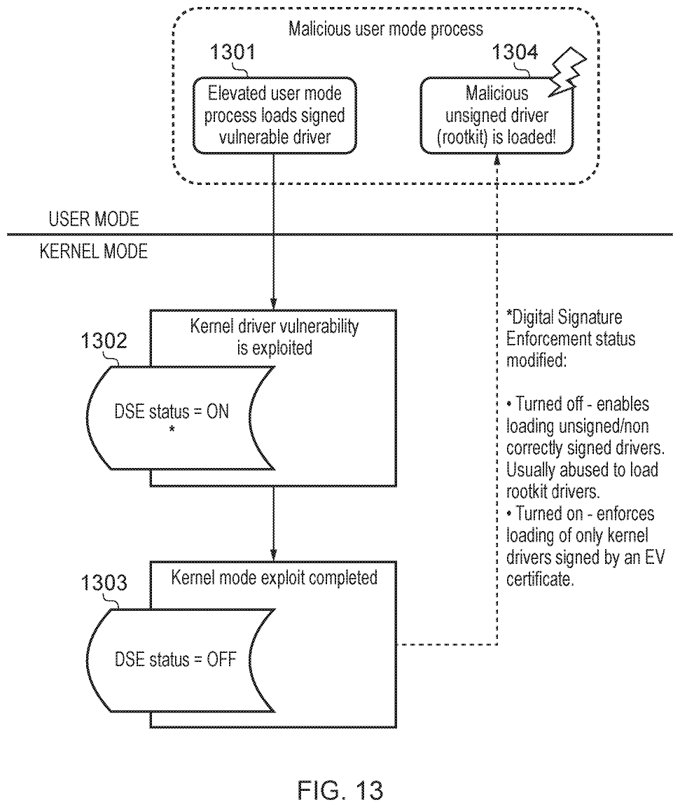

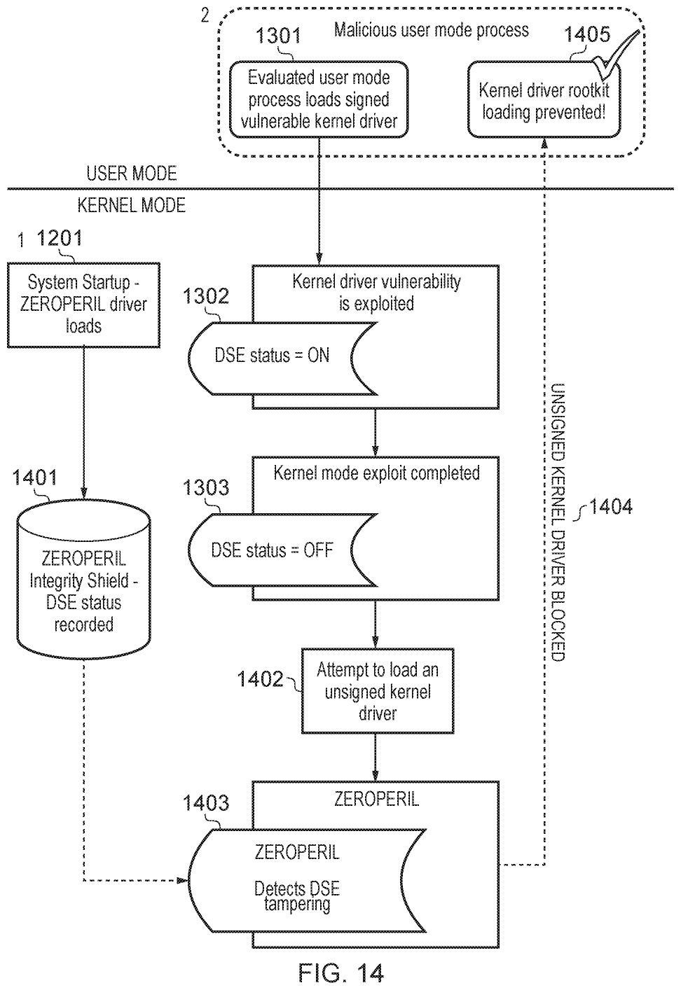

The DSE state could be modified by exploiting vulnerable software or poorly designed kernel drivers to temporarily turn DSE protection off, as illustrated in FIG. 13. It would then be possible for malware to load kernel non-cryptographically signed modules, presenting a security risk. FIG. 13 shows how a kernel mode exploit tampers with Driver Signature Enforcement flags within the kernel in order to load a rootkit driver. An elevated user mode process loads a signed vulnerable driver 1301. The kernel driver vulnerability is then exploited as a flag 1302 is modified from DSE status=ON to have DSE status=OFF 1303. When the DSE status is off, the loading of unsigned/non-correctly signed drivers is enabled. This status is usually abused to load rootkit drivers. When the DSE status is on, only the loading of kernel drivers signed by an Extended Validation (EV) certificate are allowed. The exploit allows malicious unsigned driver (rootkit) to be loaded 1304.

On system startup, the ZEROPERIL driver loads 1201. ZEROPERIL Integrity Shield 1401 copies the initial state 1302 of Driver Signature Enforcement (DSE) in the Windows® Kernel.

During callback operations and filtering operations within the Integrity Shield drivers, Integrity Shield performs additional checks on the DSE setting, comparing the setting 1303 with the original copy of the value 1302 in order to block the family of attacks detailed above. If ZEROPERIL detects DSE tampering 1403, ZEROPERIL blocks 1404 when an attacker attempts to load an unsigned kernel driver 1402. The kernel driver rootkit loading is prevented 1405. An alert may also be sent to a user.

Check: Detection of Process Protection Light Modification

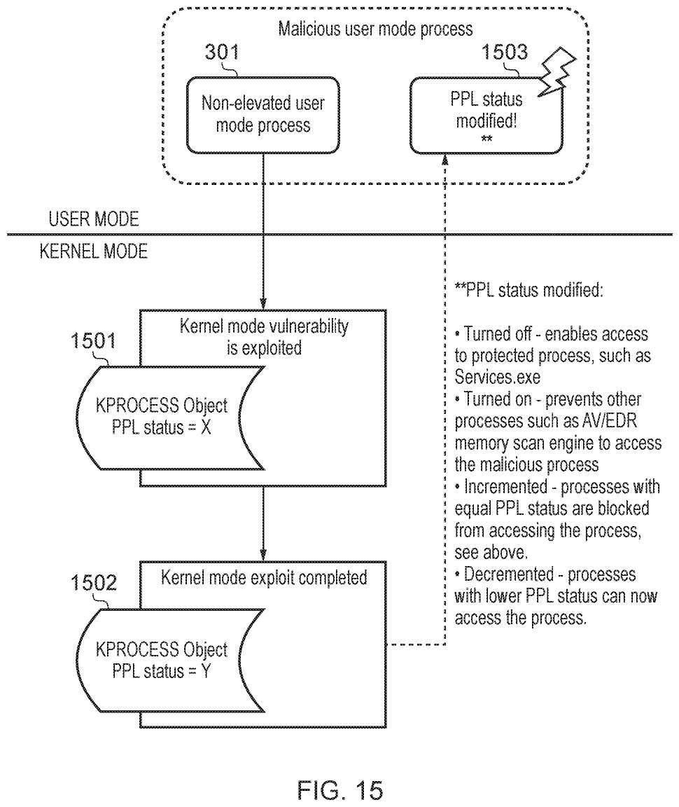

As illustrated in FIG. 15, an attacker could exploit vulnerable software or poorly designed kernel drivers to potentially alter a Process Protected Light (PPL) status 1501 allowing unauthorised access to the process 301 or denying security products access to the process 301. FIG. 15 shows a non-elevated user mode process 301 with a PPL status set to X 1501. The attacker then changes the PPL status to Y 1502. The PPL status is successfully modified 1503. When the PPL status is off, access to protected processes such as Services.exe is enabled. When the PPL status is on, other processes such as AV/EDR memory scan engine are prevented from accessing the malicious process. When the PPL status is incremented, processes with equal PPL status are blocked from accessing the process 301. When the PPL status is decremented, processes with lower PPL status can now access the process 301.

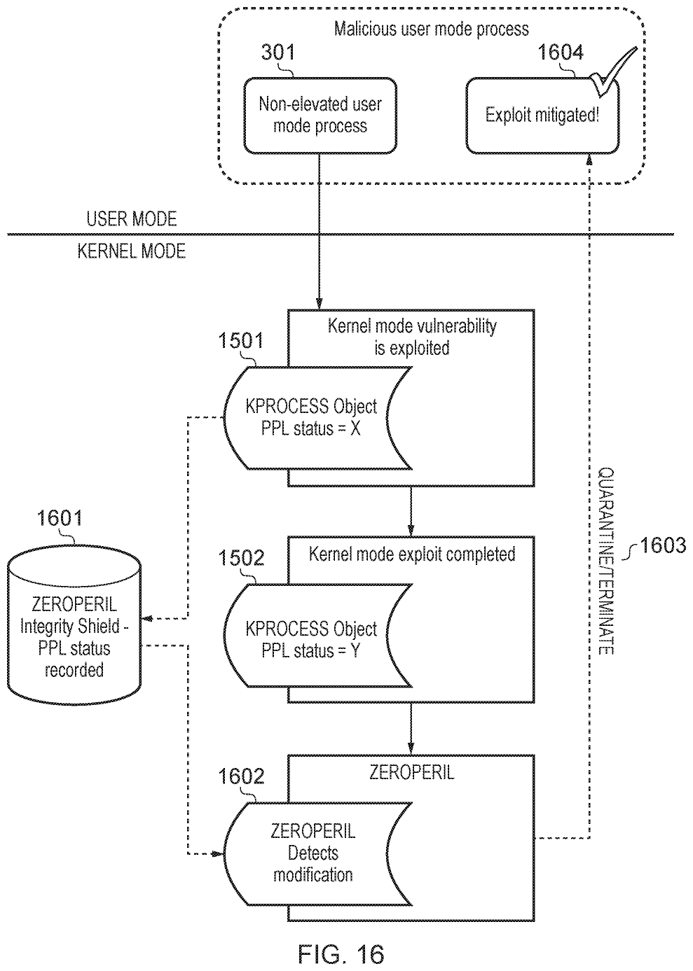

As illustrated in FIG. 16, on process 301 creation, information about the PPL status 1501 of the process is recorded into a ProcessLogEntry 201.

During callback operations and filtering operations within the Integrity Shield Drivers the current PPL level 1502 of processes is compared against the information 1501 recorded in the ProcessLogEntry 201. If PPL tampering is detected 1602 the process is either quarantined or terminated 1603. Refer to section 7 for more details on process quarantine. ZEROPERIL may alternatively or additionally send an alert to the user.

3.4. ZEROPERIL Integrity Shield Summary

Key Features of ZEROPERIL Integrity Shield May Comprise:

1. Recording (at the point of creation) specific information about Kernel data structures and Kernel objects of critical importance to security, in order to use that information later for subsequent security checks within the Windows® Kernel. (See ProcessThreadLog and ThreadLogEntry 202 section 3.3)

2. Each of the individual security checks, which are not possible to perform without the aforementioned recording of information about Kernel data, see section 3.3.3.

3. Recording the values of CPU control registers CR0, CR4 on ZEROPERIL kernel driver initialisation, in order to enable subsequent checks during for example a Kernel callback function inside the ZEROPERIL kernel driver, if the registers have been modified which indicates tampering and therefore possible exploitation.

4. Recording information about the driver signature enforcement state on ZEROPERIL kernel driver initialisation in order to enable subsequent checks during for example a Kernel callback function inside the ZEROPERIL kernel driver to compare the recorded state with the current state, a difference in the recorded value and the current value indicates tampering and therefore possible exploitation.

ZEROPERIL Integrity Shield is a system for detecting and mitigating elevation of privilege, whereby elevation is achieved if an attacker is able to perform one or more of the following:
a. Modify an ACCESS_TOKEN structure on the Windows® Operating System
b. Modify or remove a SECURITY_DESCRIPTOR
c. Modify a processes Protected Process Level (PPL)
d. Modify CR4 and/or CR0 CPU control registers
e. Modify Driver Signature Enforcement (DSE) settings

The detection is achieved by storing the following information for each process, when the process is created, into a “ProcessLogEntry” each of which resides in the “ProcessLogEntryLookup”:
a. A Boolean flag indicating if the process has an admin token initially
b. A bit mask indicating privileges not present in the initial token
c. A value storing the initial Processes Protected Process Level (PPL)
d. A Boolean flag indicating if the process initially had a Discretionary Access Control List (DACL)

The detection is further achieved by storing the following information for each thread, when the thread is created, into the “ThreadLogEntry” each of which resides in a per process “ThreadLogLookup”:
a. A Boolean flag indicating if the process initially had a Discretionary Access Control List (DACL)

Additionally, the following information is stored once globally during ZEROPERIL driver initialisation:
a. Initial CR4 and/or CR0 CPU control registers
b. Initial Driver Signature Enforcement (DSE) setting

A “trigger point” is used to initially cache the token information for each child process:
a. Creation of a child process

A “trigger point” is used to initially cache the token information for each thread in each process:
a. Creation of a thread

Various “trigger points” are used to perform checks. The trigger points are detailed below:
a. Creation of a child process
b. Creation of any thread in any process
c. Thread termination
d. Process termination
e. Registry access
f. Registry handle duplication
g. Image load
h. File system access
i. File system handle duplication
j. Named pipe access
k. Named pipe handle duplication
I. Mail slot access
m. Mail slot handle duplication
n. Opening a handle to a process
o. Duplicating a handle to a process
p. Opening a handle to a thread
q. Duplicating a handle to a thread

In response to a trigger point activation, a number of checks are performed by comparing various Kernel data with information stored in the “ProcessLogEntryLookup” or in the case of CPU control registers and Driver Signature Enforcement (DSE) values, information stored in a global variable.

Checks comprise one of more of the following for the current thread and process:
a. Checking if the process has obtained an admin token through use of “SeTokenIsAdmin”, and comparing with the stored Boolean flag value
b. Checking if privileges have been added to a process token, by probing the fields of the current process token and then using a logical AND operation with a stored value to determine if new privileges have been added
c. Checking for modification of Process Protection Light (PPL)
d. Checking if the DACL is present in a securable object that is the subject of the trigger point activation
e. Checking if the SD is present in a securable object that is the subject of the trigger point activation, and where not present, indicating the absence of a DACL

Checks additionally comprise the following:
a. Checking for tampering with CPU control registers CR0 and CR4 by comparing current value with initial value.
b. Check for tampering with Driver Signature Enforcement (DSE) state when a driver is being loaded as a consequence of trigger point activation.

In response to detecting tampering of any sort, based on the checks previously mentioned, the following actions may be taken:
a. Quarantine the operating system objects, comprising of reducing privileges of the object
b. Terminating the operating system objects
c. Blocking the operating system objects
d. Deleting the operating system objects
e. Notify the user of a discrepancy

3.5. How ZEROPERIL Integrity Shield Improves Upon the Prior Art

3.5.1. Additional Monitoring

US 2019/0325133 A1 has a single focus on malicious ACCESS_TOKEN modifications, whereas ZEROPERIL “Integrity Shield” has a wholistic approach to Kernel mode security and prevention of EoP attacks. Apart from the ACCESS_TOKEN, ZEROPERIL “Integrity Shield” additionally protects from modification and tampering to several important Kernel security data that are completely unrelated to ACCESS_TOKEN.

For example, the following items which are unrelated to ACCESS_TOKENs are monitored for tampering by “Integrity Shield”:

CR0 CPU Control Register

CR0 protects read-only Kernel memory from modification. Allowing an attacker to change CR0.wp (write protection) to zero would allow code executing in Kernel mode to write to Kernel mode and user mode read only pages, for example the checks in US 2019/0325133 A1 could be completely circumvented by an attacker copying CPU instructions into the executable pages of the Kernel driver in US 2019/0325133 A1 so that monitoring functions become inoperative or return fake results.

CR4 CPU Control Register

CR4 contains very important Kernel security flags including one for Supervisor Mode Execution Prevention (SMEP). When SMEP is enabled and the CPU is executing in Ring 0 (Kernel mode) it cannot execute instructions that reside in Ring 3 (User mode) memory pages. Which adds an additional layer of difficulty to exploitation of Kernel mode vulnerabilities.

For example, many Kernel mode exploits will use return oriented programming (ROP) in order to temporarily disable then SMEP flag in CR4, this allows the exploit to jump to a user mode address and execute further malicious code with Kernel privileges. At this point the attacker is executing code with free rein that has full system privileges and access WITHOUT requiring any modifications of ACCESS_TOKEN thus US 2019/0325133 A1 checks are completely circumvented and furthermore the checks could be removed from the system by the attacker.

CR4 additionally contains a security flag for Supervisor Mode Access Prevention (SMAP). When SMAP is enabled and the CPU is executing in Ring 0 (Kernel mode) it cannot read or write to memory pages that are owned by Ring 3 (User mode). Which adds an additional layer of difficulty to exploitation of Kernel mode vulnerabilities.

For example, a Kernel mode exploit may disable SMAP in the CR4 register and then proceed to read stored secrets, shellcode or further exploit data etc into the Kernel address space, this kind of attack does not require any modifications of ACCESS_TOKEN thus US 2019/0325133 A1 checks are completely circumvented and the exploit would not be detected at all by US 2019/0325133 A1.

Driver Signature Enforcement

Driver Signature Enforcement (DSE) prevents the Kernel from loading drivers that are not digitally signed by Microsoft® using an EV certificate, for example a malicious rootkit driver is unlikely to be signed by Microsoft.

“Integrity Shield” will check each time a system (driver) module is being loaded, the status of the DSE flag within the Windows® Kernel. If any modification is detected, loading the driver is prohibited and also loading any further Kernel mode drivers is blocked by “Integrity Shield”.

For example, as part of a kernel mode exploit, DSE may be disabled, allowing a rootkit driver to be loaded into the system. At this point the attacker is executing code with free rein that has full system privileges and access WITHOUT requiring any modifications of ACCESS_TOKEN thus US 2019/0325133 A1 checks are completely circumvented and furthermore the checks could be removed from the system by the attacker.

Securable Object Discretionary Access Control List (DACL)

“Integrity Shield” monitors for removal (setting to NULL) of the DACL of Process objects and Thread objects. Removal of the DACL by a Kernel mode exploit can allow arbitrary access from a low privileged process to a high privileged process or thread, with aim of injecting and executing malicious code in the context of a more privileged process. This doesn't require any modifications to an ACCESS_TOKEN.

For example, as part of a kernel mode exploit, a DACL may be removed from a SYSTEM service, allowing a low privileged malicious process to then inject code into the system process. At this point the attacker is executing code with free rein that has system privileges WITHOUT requiring any modifications of ACCESS_TOKEN thus US 2019/0325133 A1 checks are circumvented and the user would be unaware of the malicious activity.

Process Protection Light Status

The initial Process Protection Light (PPL) status of each process is recorded by “Integrity Shield”, an attacker could change the PPL status of a process for his own advantage. There are two common and well-known attacks against PPL processes.

The first type of attack is when the PPL level of a legitimate Windows® process is downgraded from a Kernel exploit or malicious driver, allowing a non-PPL process to read stored secrets from the downgraded process or terminate an anti-virus process.

The second type of attack is a PPL level upgrade, where an attacker upgrades the PPL level of a malicious process in order to avoid scrutiny from anti-virus (i.e. memory scanning) and protect it from termination.

US 2019/0325133 A1 is unable to detect this type of attack as the attack completely bypasses any ACCESS_TOKEN checks. Furthermore, a downgrade attack as described previously, could be used to terminate the user mode component rules engine of US 2019/0325133 A1.

3.5.2. Resource Savings

At the time of writing, each ACCESS_TOKEN structure occupies 1176 bytes of memory, a little over 1 kilobyte, US 2019/0325133 A1 optionally stores a copy of the ACCESS_TOKEN for each process running on the system, whereas “Integrity Shield” greatly improves on this storing only around 40 bytes per “ProcessLogEntry” which includes security information above and beyond that which can be obtained from an ACCESS_TOKEN meaning that Kernel pool memory resources can be use more effectively by “Integrity Shield”.

US 2019/0325133 A1 uses a SINGLE_LINKED_LIST to store the ACCESS_TOKEN information. This list structure does not allow for random access, i.e. obtaining item at index n will require list traversal of all items from the start to item n, therefore worst-case lookup of process information makes n comparisons before finding the correct item i.e. O(n). “Integrity Shield” uses a sorted array combined with a binary search, this makes at worst log n i.e. O(log n) comparisons before locating the correct item and is therefore a huge speed improvement over US 2019/0325133 A1 using less CPU resources per lookup.

3.5.3. Other Improvements

US 2019/0325133 A1 optionally caches the memory address of the ACCESS_TOKEN, in order to detect token swapping attacks. A token swapping attack typically swaps a token for one of a higher privilege level, something which can immediately be detected by examining the current token for addition of privileges or addition of the administrator SID without any reliance on the previous token address, i.e. the presence of changes to the security posture of the token indicates something awry without needing to compare a pointer, therefore “Integrity Shield” is also able to detect token swapping without need of an ACCESS_TOKEN pointer.

Secondly, US 2019/0325133 A1 makes assumptions about the functionality of the Windows® Kernel. The Windows® Kernel may change in the future with respect to ACCESS_TOKEN management, for example when the Windows® Kernel performs an update to a token, it may reallocate the token memory address, resulting in a different address, something quite innocent that US 2019/0325133 A1 would erroneously detect as a token swapping attack. “Integrity Shield” does not cache the ACCESS_TOKEN pointer at all, so it is future-proofed somewhat against such a change.

4. ZEROPERIL Security Control Enforcement

4.1. Problem: Kernel Driver Design Flaw in Use of Previous Mode

ZEROPERIL uses a unique approach named Security Control Enforcement (SCE) to detect and block kernel LPE exploits that abuse design flaws in kernel drivers that may allow a low privilege user to perform unauthorised actions through a request to the affected driver.

Most commonly, this attack is implemented by opening a Windows® Handle to the Device Object of the affected driver which is then used to send an Input/output Control (IOCTL) request.

If a driver dispatch function handling one or more IOCTLs is not properly designed, a security hole can inadvertently be created giving low privileged users access to kernel mode functionality that they should not have. These types of design problems take several forms; Security Control Enforcement is concerned with one in particular; failure to check the CPU previous mode.

Failure to Check Previous Mode

The Windows® Kernel allows user mode applications to make IOCTL requests to drivers and it also allows other kernel drivers to make the same control requests. In both cases the previous CPU mode is available to be queried by the driver servicing the request. The previous mode is either kernel mode (Ring-0) or user mode (Ring-3).

Failure to check the previous mode, leading to the assumption that the previous mode is always kernel mode can lead to severe security issues.

Windows kernel built in security checks behave differently depending on value is supplied for the previous mode parameter.

For example, the SeAccessCheck function within the Windows® Kernel API accepts a parameter “AccessMode”.

BOOLEAN SeAccessCheck(

| | |
|---|---|
| PSECURITY_DESCRIPTOR | SecurityDescriptor, |
| PSECURITY_SUBJECT_CONTEXT | SubjectSecurityContext, |
| BOOLEAN | SubjectContextLocked, |
| ACCESS_MASK | DesiredAccess, |
| ACCESS_MASK | PreviouslyGrantedAccess, |
| PPRIVILEGE_SET | *Privileges, |
| PGENERIC_MAPPING | GenericMapping, |
| KPROCESSOR_MODE | AccessMode, |
| PACCESS_MASK | GrantedAccess, |
| PNTSTATUS | AccessStatus |
| ); | |

The AccessMode parameter indicates the previous CPU mode, either kernel mode or user mode. It can be seen that incorrect assumptions of the previous mode when calling this function can result in access being granted in error, for example hard coding the CPU mode to kernel mode in the function call.

Some Windows® Kernel system call functions may have two different name aliases that either start with Nt or Zw, such as NtOpenProcess and ZwOpenProcess. The Nt versions are supposed to be used when a request is originating from user mode, which enables the kernel to do the required access check permissions internally. Many vulnerabilities originate from the fact that poorly designed kernel drivers may use the Zw versions of system call functions within their IOCTL service routines, the Zw prefixed functions set the previous CPU mode to be kernel mode and then call the Nt version of the function. It is possible to force a security check to take place by using the OBJ_FORCE_ACCESS_CHECK flag in the OBJECT_ATTRIBUTES parameter of some functions, however this can be easily overlooked by a programmer or simply not considered in the driver security design.

Failures to correctly handle the previous CPU mode may allow an unauthorized user to access privileged objects with permissions that otherwise would not be allowed.

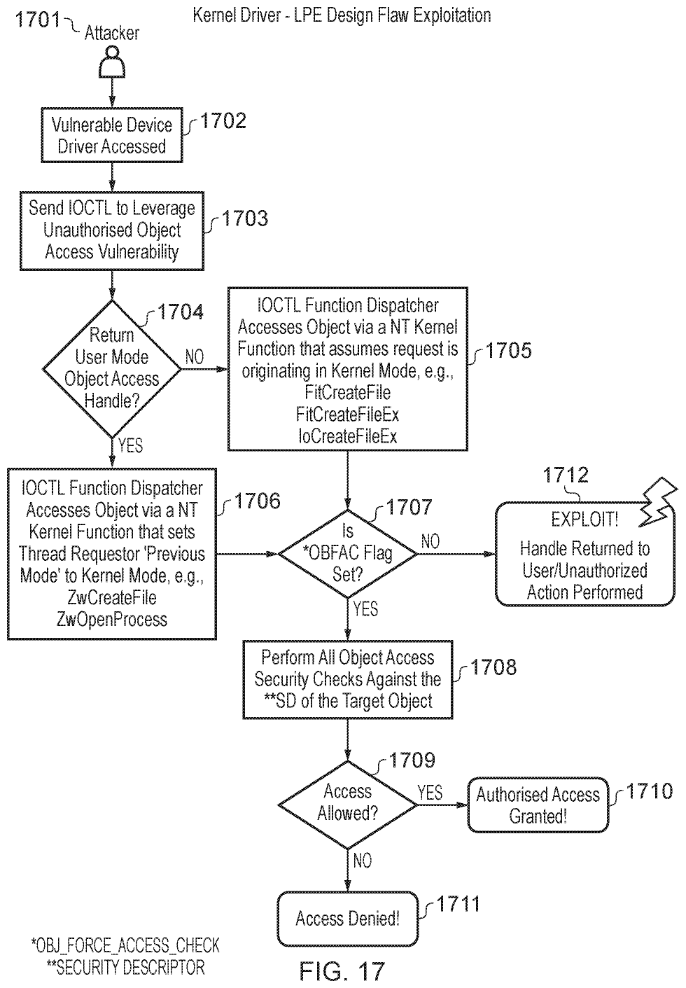

FIG. 17 shows this kernel mode exploitation without ZEROPERIL. In FIG. 17, the attacker 1701 accesses a vulnerable device driver 1702 and sends an Input/Output Control IOCTL request to leverage unauthorised object access vulnerability 1703. If a user mode object access handle is not returned 1704, the IOCTL function dispatcher accesses object via a NT kernel function that assumes the request is originating from the kernel mode 1705. If a user mode object access handle is returned 1704, the IOCTL function dispatcher accesses object via a NT kernel function that sets the thread requestor ‘previous mode’ to kernel mode 1706. The system then queries if the OBJ_FORCE_ACCESS_CHECK flag is set 1707. If the flag is set, all object access security checks are performed against the SD of the target object 1708. Based on these security checks, the system decides whether access is allowed or not 1709. If access is allowed, access is granted 1710. If access is not allowed, access is denied 1711. However, if the flag is not set, the handle is returned to user/unauthorised action performed and the exploit is successful 1712.

4.2. Solution: ZEROPERIL Security Control Enforcement

ZEROPERIL Security Control Enforcement (SCE) examines requests originating from user mode that are executed by a thread that has kernel mode as its previous CPU mode and validates that the process doing the request is allowed to access the resource.

If validation fails, then the request is blocked to effectively deny access and mitigate 0-day kernel exploits abusing such design flaws in kernel drivers.

One or more of the following Windows® securable objects may be protected by SCE:
1. File System Objects
   Validate access requests to File System objects, such as files and directories.
2. Process Objects
   Validate access requests to processes.
3. Thread Objects
   Validate access requests to threads.
4. Registry Objects
   Validate access requests to Registry Keys.

Other Windows® securable objects not listed above may also be protected, the above list is not exhaustive.

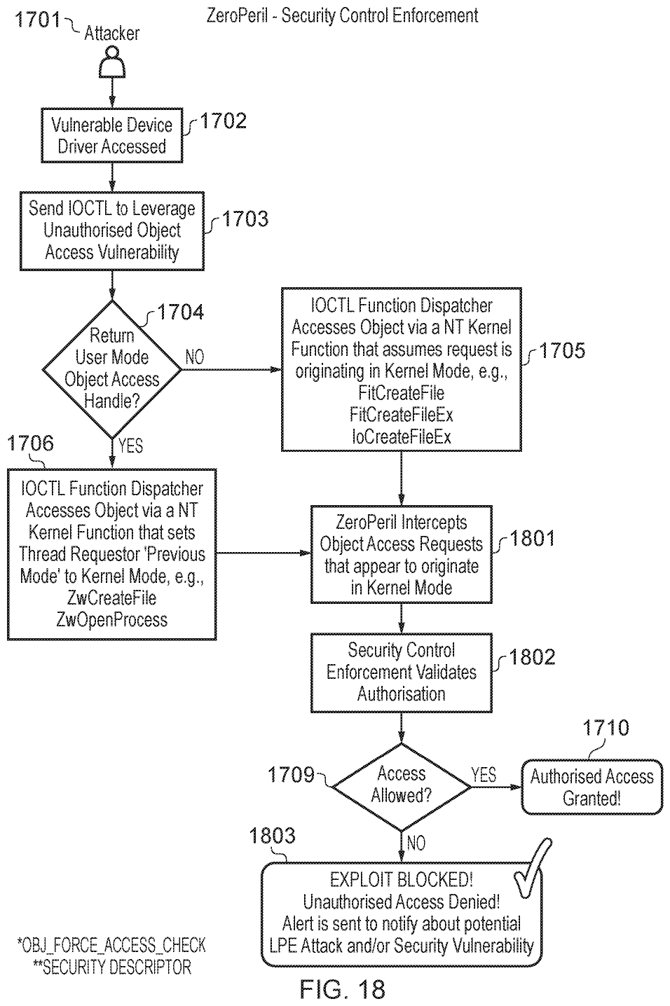

FIG. 18 shows kernel mode exploitation with ZEROPERIL. In FIG. 18, steps 1701 to 1706 are the same as in FIG. 17. However, instead of querying whether OBJ_FORCE_ACCESS_CHECK flag is set 1707, ZEROPERIL intercepts object access requests that appear to originate in kernel mode 1801. Security control enforcement then validates the authorisation 1802. The system then queries whether access is allowed 1709, as in FIG. 17. If access is allowed, access is granted 1710. If access is not allowed, the exploit is blocked 1803. Unauthorised access is denied and an alert is sent to the user to notify about a potential LPE attack and/or a security vulnerability.

4.3. ZEROPERIL Security Control Enforcement Summary

Key Features of ZEROPERIL Security Control Enforcement May Comprise:

Interception of Kernel IO requests that appear to originate from a trusted source (i.e. requested from within the Kernel indicated by “previous mode” see section 4.1) and perform an additional security check against the process performing the request (current processes context), in order to mitigate kernel driver design flaws that allow malicious code to bypass standard security checks.
a) Security check is performed against the Security Descriptor of the object that the request is attempting to access
b) Achieved by calling the SeAccessCheck Kernel API function or similar API to verify that the requestor process should indeed be granted access the target object, with the requested permissions.
c) Or, achieved by calling FltCreateFile/FltCreateFileEx/FltCreateFileEx2 or similar Kernel API function for file and directory objects using the flag “OBJ_FORCE_ACCESS_CHECK” and the flag “IO_FORCE_ACCESS_CHECK” at the appropriate locations, to verify that the requestor process should indeed be granted access the target object, with the requested permissions.
d) Or, achieved by performing an IO request to a file system “MiniFilter” driver within the filter driver stack, for file and directory objects using the flag “OBJ_FORCE_ACCESS_CHECK” and the flag “IO_FORCE_ACCESS_CHECK” at the appropriate locations, to verify that the requestor process should indeed be granted access the target object, with the requested permissions.
e) Or, achieved by file system filters intercepting I/O operations including but not limited to: IRP_MJ_CREATE, IRP_MJ_CREATE_NAMED_PIPE, IRP_MJ_CREATE_MAILSLOT and setting the SL_FORCE_ACCESS_CHECK flag in the IRP operations flags.
f) Or achieved by setting a SL_FORCE_ACCESS_CHECK flag in IRP operations flags to force the Kernel to perform access checks
g) In essence, handling the original request; such that the handled request enforces additional Kernel security checks that would not have normally been enforced.

4.4. How ZEROPERIL Security Control Enforcement Improves Upon the Prior Art

4.4.1. US 2011/239306 A1

US 2011/239306 A1 discusses intercepting user-initiated events and determining if the action is forbidden/allowed. The user-initiated events are related specifically to file re-naming, copying and deletion as well as taking screen shots, copy-pasting content and using removable storage media, all of which are of no concern to ZEROPERIL.

Instead ZEROPERIL Security Control Enforcement (SCE) is monitoring only for events that that appear to originate from Kernel mode and have a security impact. Where a driver bug exists, SCE is able to remediate/block those actions by ensuring that either:
a. The SL_FORCE_ACCESS_CHECK flag is set for IRP based file system operations in order to force the operating system to check that the current process has the required access to perform the action.
b. Intercept and execute the action with full security checks in order to force the operating system to check that the current process has the required access to perform the action

US 2011/239306 A1 uses an external database stored security policy to determine forbidden/allowed actions, whereas ZEROPERIL SCE is using the already existing and built in operating system security settings and simply enforcing a correct check against those settings, to remediate security issues caused by incorrectly programmed Kernel drivers.

ZEROPERIL SCE is operating within a different field to US 2011/239306 A1, i.e. preventing Kernel driver bugs from performing unauthorised actions on behalf of a process, something which is completely different to the aims of Data Leak Prevention.

4.4.2. US 2016/328561 A1

US 2016/328561 A1 is attempting to detect malware and rootkits whereas ZEROPERIL SCE is not attempting to detect malware, but rather it is attempting to pre-emptively remediate a specific class of Kernel driver bugs which leave a computer system vulnerable to exploitation.

US 2016/328561 A1 is examining CPU hardware or software counters, it is building a sample data set of execution addresses and CPU hardware counter values over time, with a view to using Artificial Intelligence to fingerprint these samples. ZEROPERIL SCE on the other hand is simply enforcing security checks in the Kernel that may be missed due to poorly written Kernel drivers.

5, ZEROPERIL User Mode Shield

5.1. Problem: User Mode Hooks being Unhooked

The System Service Dispatch Table (SSDT), also referred to as the System Service Descriptor Table is a table stored in kernel memory where a system call number corresponds to the index of an entry in the table, the table contains information that allows the correct system call function in the kernel to be located and is used during the kernel portion of a system call from user mode.

In Windows® XP and earlier versions, it was possible to place software code hooks into the SSDT in order to divert system calls to a different function, for example a system security check function, after checks are performed by the hook function the original system call can be called.

Since 2005 and the release of the 64 bit version of Windows® XP it has not been possible to hook the SSDT, as Microsoft® have added Kernel Patch Protection (KPP) to Windows® (informally known as PatchGuard), which prevents the modification of the SSDT. Instead, to achieve a similar effect as SSDT hooking, hooks must be placed into user mode code at the point where the system service is called inside the dynamic link library ntdll.dll.

ZEROPERIL employs user mode hooks as part of its user mode component, whereby a hooking Dynamic Link Library (DLL) is loaded into every process on the system. The hooking DLL on execution of DllMain will install hooks into the system calls within NTDLL thus allowing filtering and checks to be performed within every user mode process.

Hooking in user mode presents a problem, it is possible for malicious code to remove the hooks, since the hooks are in user-mode, and in the same process as potentially malicious code, both the hooks and the malicious code have the same level of privilege with respect to the current process. It is therefore possible using a variety of methods for malicious software to remove the hooks.

5.2. Solution: ZEROPERIL User Mode Shield

ZEROPERIL User Mode Shield is designed to detect techniques that tamper with its user mode hooks or other portions of user mode code that should not be modified, on detection of tampering action can then be taken, such as quarantining the process (see section 7).

Some hook removal techniques will replace jmp (jump) instructions to the hook code with the original code within the hooked functions. By using a watchdog thread to monitor the sections of memory where the hooks reside, ZEROPERIL can detect tampering.

Using a watchdog thread to monitor/poll the state of something is not a new approach within the field of Software Engineering, however the use of a watchdog thread, optionally within every process on the system, monitoring user mode hooks is a new approach to security, ZEROPERIL user mode shield also takes the technology much further by adding layers of additional protection.

The ZEROPERIL watchdog thread may yield execution for a random amount of time and when it wakes it will check the memory locations where ZEROPERIL user mode hooks reside to determine if they have the correct values or if they have been modified. The checking may be performed by using a hashing algorithm for example a Cyclic Redundancy Check (CRC32) to detect tampering with the hooked memory addresses, but any differencing check can be used. It will then repeat the loop sleeping for a random amount of time before checking again, and so on. See below for an example pseudo code representation of this.

```
Loop:
  For memoryLocation in watchedMemoryLocations:
    previousValue = Lookup previous value of memoryLocation
    if currentValue not equal previousValue:
      call tamperingDetected
  sleepTime = call randomRangeMilliseconds( 400, 3000 )
  call sleep sleepTime
Goto Loop:
```

ZEROPERIL may create a single system watchdog thread in the Kernel address space to monitor all processes, allowing the thread to be protected from user mode tampering automatically by the fact that only code running in kernel mode can have access to it.

Due to the fact that the hooks will not change for the lifetime of a hooked process, ZEROPERIL prevents this form of attack by placing the list of memory addresses to verify, into a read-only mapped memory location (PAGE_READ) in the virtual address space of each process and by enabling the SEC_NO_CHANGE flag on this memory, thus disallowing modification of the data. The location of this memory page can be either located at a fixed virtual address in each process or the address can be transmitted to the Kernel watchdog thread via Device Driver IOCTL or other means, thus allowing the list of watched memory locations to be updated as required.

Alternatively, the watchdog thread can be created in user mode, one per process, in which case ZEROPERIL adds one or more of the following extra protections to the watchdog thread:
1. The DACL on the thread is set to only allow read access by NT AUTHORITY\SYSTEM (S-1-5-18) which prevents tampering with the thread by all processes on the system.
   The Security Descriptor Definition Language (SSDL) representation of this DACL is as follows:
   D: (A;;RC;;;S-1-5-18)
2. Without ZEROPERIL, an attacker, for example, wishing to circumvent the protection provided by the aforementioned DACL on the watchdog thread, could obtain the SeDebugPrivilege (SE_DEBUG_NAME) privilege which would allow access to the user mode thread despite the restrictive DACL
   ZEROPERIL prevents this form of attack by using the ZEROPERIL kernel driver to restrict access when opening the user mode watchdog thread handle, of any process running with lower than system integrity level during the pre-operation callback of a thread open operation in the Windows® Kernel.
3. Without ZEROPERIL, another way an attacker could circumvent this kind of user mode watchdog thread is to modify, replace or tamper with the executable code (for example place a (ret) return instruction) for the watchdog thread, with a view to preventing the memory checks performed by the watchdog thread, causing the execution to return and the checks to be skipped.
   In order to also protect the user mode watchdog thread code from tampering as described above, ZEROPERIL maps the code of the thread function into a page with page protection PAGE_EXECUTE_READ and also sets the SEC_NO_CHANGE flag on the mapped memory pages, in order to prevent modification of the pages where the watchdog code resides.
4. Without ZEROPERIL, a further attack method to disable the user mode watchdog thread would be for the attacker to locate and to modify the list of memory addresses that need to be checked.
   Due to the fact that the hooks will not change for the lifetime of the hooked process, ZEROPERIL prevents this form of attack by placing the relevant data into a read-only mapped memory location (PAGE_READ) and by enabling the SEC_NO_CHANGE flag on this memory, thus disallowing modification of the data. This takes place before the user mode watchdog thread is started.

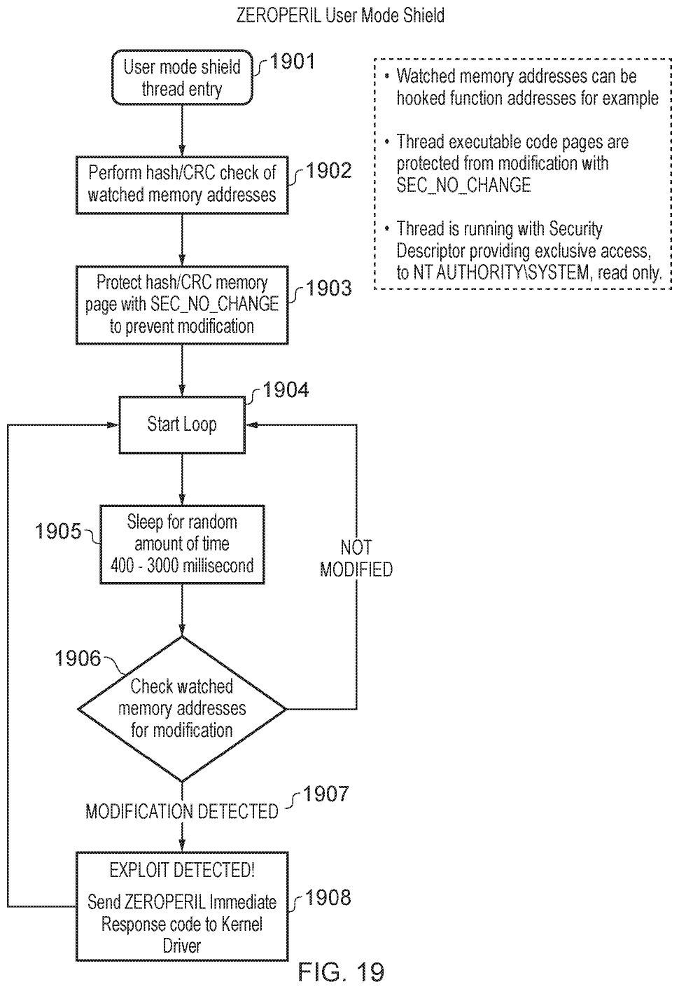

FIG. 19 is a flow chart showing how user mode shield may work. In FIG. 19, a user mode shield thread is entered 1901. Thread executable code pages may be protected from modification with SEC_NO_CHANGE. A comparison, e.g., hash and/or CRC check of watched memory addresses is performed 1902. Watched memory addresses may be hooked function addresses. The memory page containing the list of addresses to check (e.g., hash/CRC memory page) is protected with SEC_NO_CHANGE to prevent modification 1903. A monitoring loop is then started 1904. The system sleeps for an amount of time 1905. This amount of time may be between 400 and 3000 milliseconds. This amount of time may be randomly determined. The system wakes up and checks the watched memory addresses for modifications 1906. If no modifications are detected, the loop begins again 1904. If a modification is detected 1907, then an exploit is detected 1908 and in the case of a user mode watchdog thread ZEROPERIL Immediate Response code is sent to the kernel driver 1908. The loop then begins again 1904.

5.3. ZEROPERIL User Mode Shield Summary

Key features of ZEROPERIL User Mode Shield may comprise one or more of:

1. Creating a user mode or system thread which periodically checks for changes at various memory locations within an application, locations that are important to the security of the application or are important to the operation of security checks, by comparison of hashes/crc or comparison of the data at the monitored addresses. Detection of a modification to a monitored address indicates tampering and possible exploitation.

2. Protecting the aforementioned thread from termination, modification or otherwise tampering by setting a Security Descriptor an appropriate DACL on the thread, to prevent write access from everyone except the Kernel.

3. Further protecting the list of monitored memory addresses by placing this list into a memory page that is read only and has the SEC_NO_CHANGE flag set, thus preventing write access from ever being obtained in the future for this memory range.

4. Further protecting the aforementioned user mode thread by placing the executable code of the thread into a memory page that has read and execute permissions and also has the SEC_NO_CHANGE flag set, thus preventing write access from ever being obtained in the future for this memory range.

ZEROPERIL user mode shield is designed to detect and prevent tampering with user mode hooks.

User mode hooks are portions of user mode executable code within a process that has been overwritten by other aspects of ZEROPERIL in order to re-direct the execution flow. A typical usage for this is to perform security checks on a function.

In order to maintain these security checks, it is important that these function hooks are not overwritten or otherwise tampered with by malicious code. This is where “User mode shield” steps in.

A single system thread, or a user mode thread per process is created which monitors the overwritten memory addresses for changes at specified intervals, usually this is done by using a CRC (fingerprint) of the expected memory contents.

Additionally, portions of executable code belonging to ZEROPERIL within a process are protected from modification by remapping the memory pages as “SEC_NO_CHANGE” or alternatively using “PAGE GUARD” to detect modifications.

5.4. How ZEROPERIL User Model Shield Differs from the Prior Art

5.4.1. US 2016/328561 A1

User mode shield is concerned with detecting and preventing tampering with known memory addresses.

US 2016/328561 A1 is attempting to detect unknown root kit behaviours by statistical and machine-learning (ML) analysis of operating system and CPU counters over time.

User mode shield is creating CRC/Hash/Fingerprints of known memory locations that have been previously modified by ZEROPERIL in order to improve security. The CRC/Hash/Fingerprints are periodically checked and if they differ, then it is clear that modification has taken place.

User mode shield is only concerned with user mode, whereas US 2016/328561 A1 is concerned only with Kernel mode.

US 2016/328561 A1 is generating fingerprints based on machine performance data samples and unspecified execution address samples over time. A number of baseline readings are taken on computers that are known to be clean (i.e. not infected with a rootkit) and this information is used to train a neural-network which can then be used to determine if subsequent readings “in the wild” deviate from the expected neural-network output.

US 2016/328561 A1 does not know what the execution addresses it samples will be in advance. ZEROPERIL only examines specific known in advance addresses and is not concerned with random execution addresses.

6. ZEROPERIL Immediate Response

6.1. Problem: Communication of Issues; User Mode to Kernel Mode

There are several well documented ways in which a user mode process can communicate information to a Windows® kernel driver:
Use of IOCTL via DeviceloControl
Use of Filter Manager

For security reasons, communication with the kernel most often goes via an intermediary system service. User mode services will use a well-known inter-process communication method to communicate with a system service for example:
Named pipe
Shared memory
Mail slots
Network sockets
RPC—Remote procedure call
ALPC—informally known as Advanced Local Procedure Call

The intermediary system service can then forward the information to the relevant kernel driver using DeviceloControl or Filter Manager.

Using these methods presents several problems:
1. Direct communication with a kernel driver
   Allowing any low privileged user mode process to communicate directly with a kernel driver could allow for privilege escalation if a bug exists in the kernel driver communication code. This is an often-used attack vector for malicious actors and exploit code.
2. Communication with a kernel driver via an intermediary process
   Low privileged user mode processes which communicate with kernel drivers via an intermediary high privileged user mode process, do not generally have the ability to exploit bugs in kernel driver code as the intermediary process acts as a buffer between the kernel and the low privileged process.
   It is still possible however for exploitable bugs to exist in the intermediary process, possibly leading to elevation of privilege.

Another issue with using any of the existing methods of communication, is the time taken to communicate. It takes time to connect to an intermediary service, and speed can also be affected by any protocols used to negotiate a connection.

When sending data regarding security issues, to a kernel driver, communication needs to be as fast as possible, for example a malicious process may terminate in order to try and stop the reporting of any issues to the kernel.

6.2. Solution: ZEROPERIL Immediate Response

ZEROPERIL Immediate Response leverages two features of Microsoft® Windows® in a novel way in order to communicate rapidly with the ZEROPERIL kernel drivers.

As discussed in section 3.3.2 it is possible within the Windows® kernel to add a callback within a Windows® kernel driver that allows the driver to be notified when a new thread is created or an existing thread terminates. By leveraging this callback it is possible to send simple information such as flag values or integers indicating some known value, from a process to the Kernel.

The system works by first allocating a known virtual address range into a subject process. This can be done in a variety of ways, however in the case of ZEROPERIL a Portable Executable (PE) file section is allocated within a Dynamic Link Library (DLL). The DLL is then loaded into every process as the process starts. DLL Injection from kernel mode to user mode can be achieved in a variety of ways, the most common being to queue a user mode Asynchronous Procedure Call (APC) from a driver in the Windows® Kernel, the method is not relevant, only establishing a known virtual address range within a process is key to the operation of Immediate Response.

A Windows® kernel image load notify callback is used to track DLL loading in each process, and the base address of the injected DLL is recorded for each process, using the ProcessLogEntry 201 (see section 4.2). In this way it is possible to know the exact location within each process of the virtual address range (referred to as the immediate response address range) associated with the PE section added to the injected DLL.

In order to send information to the kernel from a particular process, for example when the ZEROPERIL User Mode Shield detects tampering, a thread is created in user mode in the subject process, with an offset from the known virtual address range, with THREAD_PRIORITY_TIME_CRITICAL priority. The kernel thread callback can obtain the thread start address and calculate the offset from the start of the known virtual address range, the value of the offset being the data we want to send to the kernel.

By placing a small code stub at regular offsets inside the immediate response address range, each stub returning the thread parameter, it is possible to also pass a parameter to the thread and read this value in the kernel by interrogating the thread return code.

Shown below is pseudo code for the user mode component and the kernel mode component respectively, in terms of sending the data point with value 123 to the ZEROPERIL kernel driver and parameter with value 456. The data point with value 123 can represent some meaning for example a code to signify tamper detection with the user mode process and the parameter some value with significance to the data value.

In the code below, the stubSize variable indicates the distance in bytes between each code stub contained within the immediate response address range. This can be used to calculate the data value, by first determining the offset of the thread start address, from the known immediate response address range, then dividing the result by the stubSize to obtain the original data value.

Pseudo code for the user mode component of the Immediate Response thread:

data = 123
parameter = 456
threadStartAddress = knownVirtualAddress + (data * stubSize)
threadId = call createThread( threadStartAddress, parameter )

Pseudo code for the kernel mode component of the Immediate Response thread, calculating data and parameter values:

sectionSize=getSectionSize( )

sectionSize is an arbitrary/opaque value.

```
OnThreadTerminate:
  threadStartAddress = call getThreadStartAddress( )
  if threadStartAddress < (knownVirtualAddress + sectionSize):
    if threadStartAddress >= knownVirtualAddress:
      data = (threadStartAddress − knownVirtualAddress) /
stubSize
      parameter = getThreadReturnCode( )
```

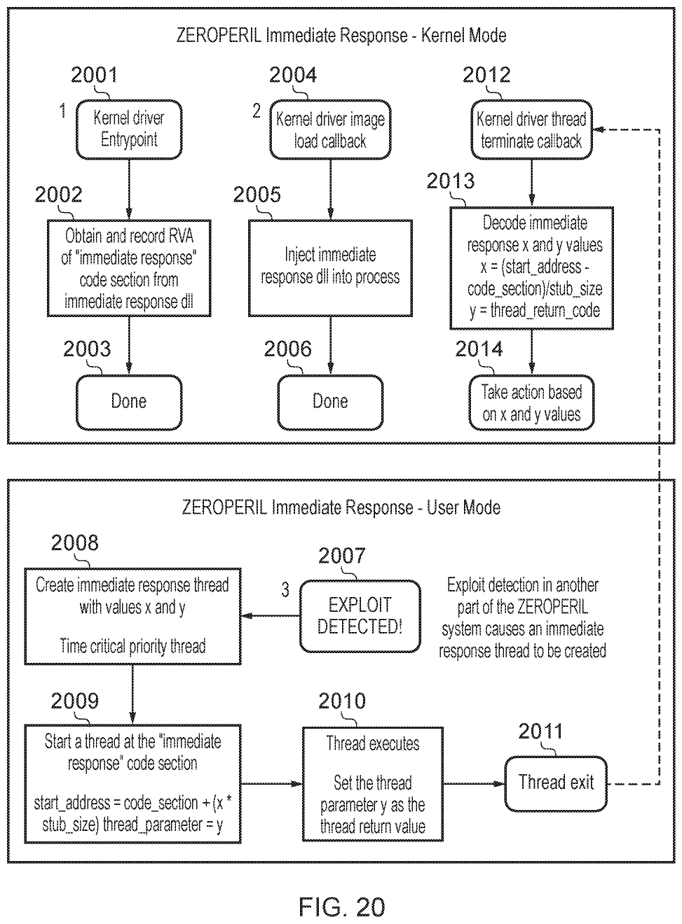

FIG. 20 shows a flow chart of how an Immediate Response thread may work. Section 1 starts from the kernel driver entrypoint 2001. The relative virtual address (RVA) of “immediate response” code section from immediate response dynamic-link library (dll) is obtained and recorded. This completes 2003 section 1. Section 2 starts from a kernel driver image load callback 2004. The immediate response dll is injected into the process 2005. This completes 2006 section 2. Section 3 starts from when an exploit is detected 2007. Exploit detection in another part of the ZEROPERIL system causes an immediate response thread to be created. An immediate response thread with values x and y is created 2008. This is a time critical priority thread. A thread is started at the “immediate response” code section 2009 (for example, start_address=code_section+(x*stub_size) thread_parameter=y). The thread then executes 2010. The thread_parameter y is set as the thread return value. The thread then exits 2011. The kernel driver thread terminates the callback 2012. The immediate response x and y values are decoded 2013 (for example, x=(start_address−code_section)/stub_size and y=thread_return_code). Action is then taken based on the x and y values 2014.

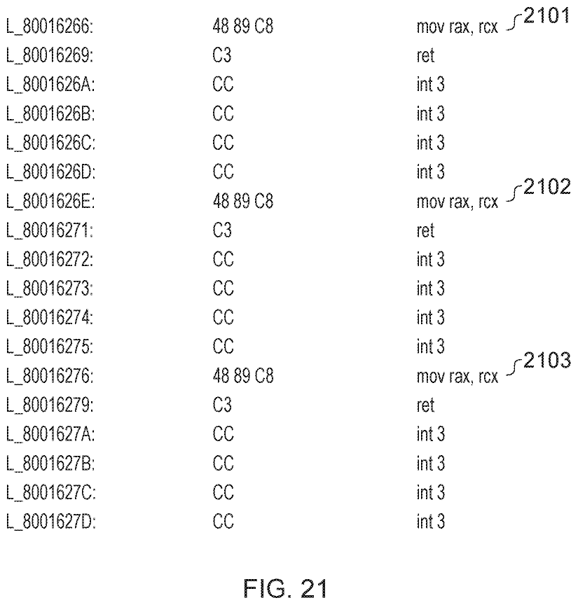

FIG. 21 shows three example 64-bit thread code stubs 2101, 2102, 2103, where immediate response threads can be created, each stub simply takes the thread parameter stored in CPU register rcx and returns this as the thread return code which can then be read in the Kernel. The immediate response address range would normally contain the same number of stubs as the number of discrete data values that need to be sent to the Kernel.

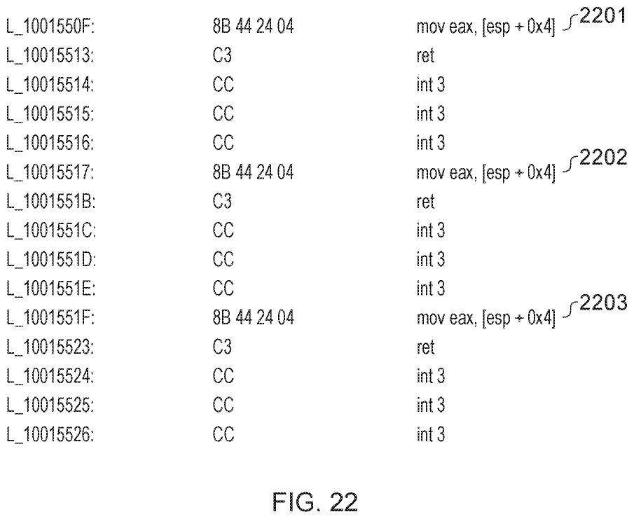

FIG. 22 shows example 32-bit thread code stubs 2201, 2202, 2203, where immediate response threads can be created, each stub simply takes the thread parameter stored on the stack and returns this as the thread return code which can then be read in the Kernel. By using this method two data values can be immediately sent directly to the Windows® Kernel and intercepted in order to take some action such as process quarantine (see section 7) and/or sending an alert to a user for example.

6.3. ZEROPERIL Immediate Response Summary

Key Features of ZEROPERIL Immediate Response May Comprise:

1. Using the creation of a thread of execution in order to communicate arbitrary data to the ZEROPERIL kernel drivers, through the use of a “known address” within a running process, whereby the thread entry point is at an offset from this “known address”. A calculation determining the distance of the entry point from the “known address” is used to work out the value of the data point being sent.

2. Using a code “stub” within the “known address” range, where the aforementioned thread is created, the stub copies the parameter passed upon thread creation, and sets this value as the thread return value. The size of the code stubs is considered in the calculation of the data point.

3. Marking the aforementioned thread as THREAD_PRIORITY_TIME_CRITICAL priority in order to ensure that the thread is scheduled to run as soon as possible.

4. Combining the above techniques to simultaneously send two data points that are intercepted by the ZEROPERIL kernel driver at the point of thread termination. (This avoids other slower, official forms of communication with the Kernel that exist within the Windows® API such as the FltManager).

6.4. How ZEROPERIL Immediate Response Improves Upon the Prior Art

6.4.1. US 2018/239657 A1

ZEROPERIL Immediate Response is a uni-directional communication method i.e. it can only send messages from user mode to Kernel mode, furthermore it is only able to send a tiny amount of data which is limited to:
a. A message identifier (based on the offset of the thread entry point)
b. A 32 bit message data

US 2018/239657 A1 is bi-directional and can send any sized message from Kernel mode to user mode.

The use cases for each of these inventions is different. ZEROPERIL Immediate Response is used when a near instantaneous message is required to be sent only to the Kernel with no response required, whereas US 2018/239657 A1 is used when detailed message data needs to be sent back and forth between the Kernel and user mode at a much slower rate.

ZEROPERIL Immediate Response does not require any connection setup in terms of being initially disconnected, waiting and the becoming connected or failing to connect as with US 2018/239657 A1. In fact, ZEROPERIL IR is designed to be more or less instantaneous in sending a message to the Kernel and the speed of this prevents circumvention by an attacker terminating the process before a message can be sent.

It can be seen that with US 2018/239657 A1, while the connection is being established to the endpoint, the process can be terminated, thus preventing the message from being sent in the first place.

ZEROPERIL Immediate Response sending mechanism is completely different to that of US 2018/239657 A1. ZEROPERIL IR makes use of user mode thread creation and destruction events received in the Kernel by a thread creation callback, and as such, even maliciously terminating the thread does not stop the message from being received.

US 2018/239657 A1 allows sending of data from an un-trusted user mode application to the Kernel, as does ZEROPERIL IR. The difference here is that US 2018/239657 A1 messages will require some sort of deserialization/parsing in the Kernel, which could be a risk in terms of any bugs in such code leading to a Kernel exploit i.e. allowing an unprivileged process to run privileged Kernel code. ZEROPERIL IR completely removes all risk here as there are only two data points being sent, a message id and a single 32 bit value representing some arbitrary informational code i.e. there is no parsing or deserialization of the message required.

7, ZEROPERIL Process Quarantine and Termination

7.1. ZEROPERIL Process Quarantine Description

When a component of ZEROPERIL, such as Integrity Shield, Security Check Enforcement or User Mode Hook Shield detects that a process is the source of malicious behaviour the process may be terminated and/or the user may be notified.

Some processes are critical to the stability of Windows® and cannot be terminated without adverse effects, for example the Isass.exe process is system critical and will result in a Windows® bug check if terminated. System critical process can instead be put into a quarantine state and the user notified. Optionally the ZEROPERIL user may turn the process termination option off, resulting in malicious processes being quarantined instead of terminated.

Processes that are quarantined will have privileges reduced by ZEROPERIL kernel driver components.

Reduction in privilege for quarantined processes is achieved by prohibiting one or more of the following actions using the Windows® Kernel callbacks in the ZEROPERIL drivers:
Creation of child processes
Creation of threads within other processes, even when the process handle was open prior to the process being quarantined

Reduction in privilege is further achieved by filtering the level of access that can be obtained when one or more of the following actions are intercepted using the Windows® Kernel callbacks in the ZEROPERIL drivers:
Opening a handle to a process
Duplicating a handle from a process
Opening a handle to a thread
Duplicating a handle to a thread
Opening or duplicating a handle of a file, named pipe or mailslot
Opening or duplicating a handle of a registry key

For example, a quarantined process may request the PROCESS_ALL_ACCESS access mask when it attempts to open another process. ZEROPERIL in this case, through the ZEROPERIL kernel drivers, filter the requested access to a maximum value of PROCESS_QUERY_LIMITED_INFORMATION combined with SYNCHRONIZE if requested, thus preventing a quarantined process from further malicious action.

Thread handles can be filtered in a similar way by setting the maximum access to THREAD_QUERY_LIMITED_INFORMATION combined with SYNCHRONIZE if requested and registry key handle access can also be filtered so that the maximum access allowed is KEY READ access.

Quarantined process will be denied write, delete and rename access to file systems and will be denied the ability to connect to resources over the network which will be achieved by ZEROPERIL using the Windows® Filtering Platform API.

7.2. ZEROPERIL Process Quarantine Summary

Key features of ZEROPERIL Process Quarantine may comprise:

1. Using the data structures defined in section 4.2 in order to record that a particular process should be subsequently treated as quarantined.

2. Preventing a process marked as quarantined from creating a child process.

3. Preventing a process marked as quarantined from invasive interaction with other processes for example, one or more of:
a) Creating a thread within another process
b) Reading and writing memory within another process
c) Duplicating or accessing handles from another process
d) Interrogating the security token of another process or thread
e) Suspending, resuming and terminating another process
f) Suspending, resuming and terminating a thread belonging to another process.

4. Preventing a process marked as quarantined from modifying, creating or deleting registry keys.

5. Preventing a process marked as quarantined from modifying, creating or deleting files.

6. Preventing a process marked as quarantined from accessing untrusted/non-whitelisted network addresses.

7. In response to a request to access an operating system object, the set of access permissions granted is modified to become a less privileged subset of the permissions requested.

8. Computer System

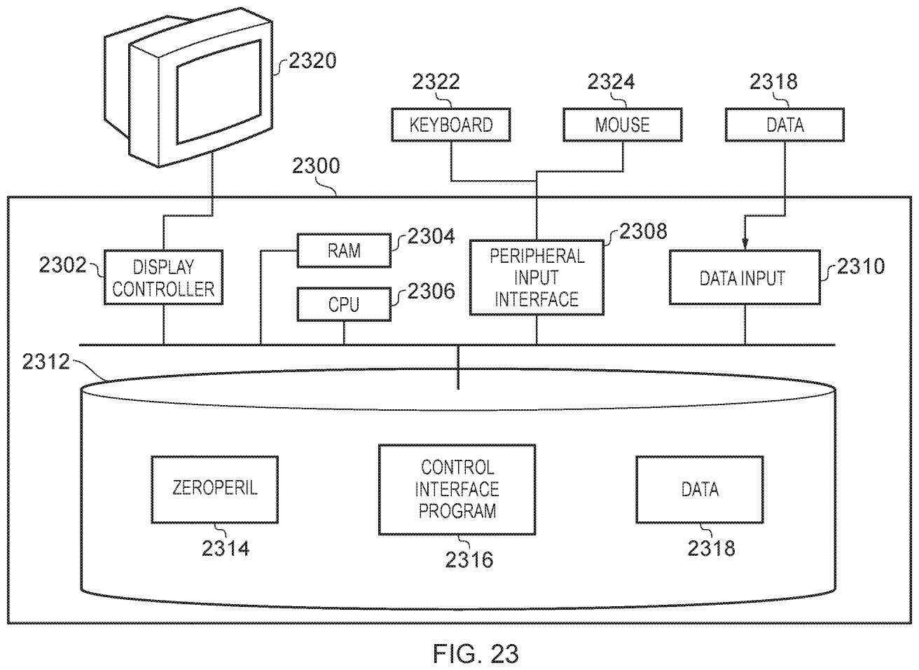

An example of a computer system used to perform embodiments of the present invention is shown in FIG. 23.

FIG. 23 is a block diagram illustrating an arrangement of a system according to an embodiment of the present invention. Some embodiments of the present invention are designed to run on general purpose desktop or laptop computers. Therefore, according to an embodiment, a computing apparatus 2300 is provided having a central processing unit (CPU) 2306, and random-access memory (RAM) 2304 into which data, program instructions, and the like can be stored and accessed by the CPU. The apparatus 2300 is provided with a display screen 2320, and input peripherals in the form of a keyboard 2322, and mouse 2324. Keyboard 2322, and mouse 2324 communicate with the apparatus 2300 via a peripheral input interface 2308. Similarly, a display controller 2302 is provided to control display 2320, so as to cause it to display images under the control of CPU 2306. Data 2318, can be input into the apparatus and stored via data input 2310. In this respect, apparatus 2300 comprises a computer readable storage medium 2312, such as a hard disk drive, writable CD or DVD drive, zip drive, solid state drive, USB drive or the like, upon which data 2318 can be stored. Computer readable storage medium 2312 also stores various programs, which when executed by the CPU 2306 cause the apparatus 2300 to operate in accordance with some embodiments of the present invention. Alternatively, data and/or programs may be stored on a web-based platform, e.g. a database, and accessed via an appropriate network.

In particular, a control interface program 2316 is provided, which when executed by the CPU 2306 provides overall control of the computing apparatus, and in particular provides a graphical interface on the display 2320, and accepts user inputs using the keyboard 2322 and mouse 2324 by the peripheral interface 2308. The control interface program 2316 also calls, when necessary, other programs to perform specific processing actions when required. The control interface program also loads additional functionality from external modules for example, a ZEROPERIL module 2314 may be provided and loaded when indicated by the control interface program 2316. The operations of the ZEROPERIL module 2314 are described in more detail above.

The detailed operation of the computing apparatus 2300 will now be described. Firstly, the ZEROPERIL module 2314 is launched without user interaction and operates as described above. The ZEROPERIL module 2314 is a kernel module which extends the kernel. The ZEROPERIL module 2314 launches without interaction so that protection is established as soon as the kernel begins loading additional modules.

Various modifications whether by way of addition, deletion, or substitution of features may be made to above-described embodiment to provide further embodiments, any and all of which are intended to be encompassed by the appended claims.

1. A computer implemented method for detecting and blocking malicious actions in a computer operating system, the method comprising:
recording a first status of operating system kernel data upon initiation of one or more operating system events;
recording a second status of the operating system kernel data in response to a system call triggering the one or more defined operating system events;
performing one or more security checks, the one or more security checks comprising comparing the first status to the second status;
detecting any discrepancies between the first status and the second status; and
if a discrepancy is detected, taking appropriate action based on the discrepancy;
wherein the operating system kernel data comprises one or more of the following:
(i) CPU control registers;
(ii) driver signature enforcement state;
(iii) discretionary access control list of a process and/or a thread;
(iv) process protection light status of a process.

2. The computer implemented method of claim 1, wherein the operating system kernel data comprises one or more of the following:
(i) process information; and/or
(ii) thread information.

3. The computer implemented method of claim 1, wherein the one or more operating system events comprise one or more of the following:
(i) Kernel drivers being loaded
(ii) Process creation
(iii) Process termination
(iv) Thread creation
(v) Thread termination
(vi) Module/dynamic link library mapping for execution
(vii) Request to open or to duplicate an operating system handle to a process object
(viii) Request to open or to duplicate an operating system handle to a thread object
(ix) Request to open or to duplicate an operating system handle to a registry key
(x) Request to open or to duplicate an operating system handle to a file
(xi) Request to open or to duplicate an operating system handle to a directory
(xii) Request to open or to duplicate an operating system handle to a named pipe
(xiii) Request to open or to duplicate an operating system handle to a mail slot
(xiv) Request to open or to duplicate an operating system handle to a device object.

4. The computer implemented method of wherein the one or more security checks comprise one or more of the following:
(i) checking whether an administrator group Security Identifiers, SID, has been added to a process token;
(ii) checking whether a privilege has been added to a process token;
(iii) checking whether a Discretionary Access Control List, DACL, is present within a securable object;
(iv) checking whether a Security Descriptor, SD, is set to “NULL”;
(v) checking whether CPU control registers have been tampered with;
(vi) checking whether a driver signature enforcement state has been tampered with; and/or
(vii) checking whether a Process Protection Light, PPL, status has been tampered with.

5. The computer implemented method of wherein the appropriate action comprises one or more of:
(i) notifying a user of the discrepancy;
(ii) quarantining operating system objects associated with the operating system event; and/or
(iii) terminating and/or blocking and/or deleting the operating system objects associated with the operating system event.

6. The computer implemented method of claim 5, wherein quarantining the operating system objects comprises reducing granted privileges and/or prohibiting actions in response to the operating system event.

7. The computer implemented method of claim 6, wherein reducing the privileges comprises prohibiting one or more of:
(i) creating a child process;
(ii) creating a thread within another process;
(iii) reading and/or writing memory within another process;
(iv) duplicating and/or accessing handles from another process;
(v) interrogating the security token of another process or thread;
(vi) suspending, resuming and/or terminating another process;
(vii) suspending, resuming and/or terminating a thread belonging to another process;
(viii) limiting registry access of the operating system objects;
(ix) limiting file system access of the operating system objects;
(x) limiting network access of the operating system objects; and/or
(xi) in response to a request to access an operating system object, a set of granted access permissions is modified to be a less privileged subset of a set of requested permissions.

8. A computer implemented method for detecting and blocking exploitation of kernel driver design flaws from being used for malicious actions in a computer operating system, the method comprising:
detecting where a kernel Input/Output request originates from;
if the request originates from a kernel mode, performing a security check against a process performing the request, wherein the security check comprises checking whether the process is authorised to perform the request; and
if the process is not authorised to perform the request, blocking the request.

9. The computer implemented method of claim 8, wherein the security check is performed against the security descriptor of an object that the request is attempting to access.

10. The computer implemented method of claim 8, wherein the security check is performed by calling a Kernel API function, such as a SeAccessCheck Kernel API function, a FltCreateFile Kernel API function, a FltCreateFileEx Kernel API function, or a FltCreateFileEx2 Kernel API function.

11. The computer implemented method of claim 8, wherein the security check is performed by an Input/Output request to a file system MiniFilter driver within a filter driver stack.

12. The computer implemented method of claim 8, wherein the performing the security check comprises:
handling the request such that the handled request enforces additional Kernel security checks; and/or
setting a SL_FORCE_ACCESS_CHECK flag in IRP operations flags to force the Kernel to perform access checks.

13. A computer implemented method for detecting and blocking tampering within user mode portions of a security system, the method comprising:
creating a thread which periodically compares one or more first statuses of one or more memory locations within an application to one or more second statuses of the one or more memory locations within the application, each memory location having a corresponding first and second status;
detecting, by the thread, any discrepancies between one or more corresponding first and second statuses;
if a discrepancy is detected, taking appropriate action based on the discrepancy; and
wherein the thread is protected from tampering.

14. The computer implemented method of claim 13, wherein the thread is protected from tampering by setting a Security Descriptor an appropriate Discretionary Access Control List, DACL, on the thread such that only a kernel has ‘write’ access to the thread.

15. The computer implemented method of claim 13, wherein the thread is protected from tampering by blocking access to the thread from within a kernel callback.

16. The computer implemented method of claim 13, wherein the thread is protected from tampering by placing a list of the one or more memory locations into a first memory page and optionally adding a PAGE_GUARD flag onto the first memory page.

17. The computer implemented method of claim 16, wherein the thread is protected from tampering by placing executable code of the thread into a second memory page, and wherein the first and second memory pages have a read only status and have protections such that the read only status cannot be changed.

18. (canceled)

19. The computer implemented method of wherein the thread is protected from tampering by using a mapping process, the mapping process comprising:
firstly, mapping a file into a virtual address space of a process associated with the thread;
secondly, storing the one or more memory locations in the file; and
thirdly, unmapping the file;
while the mapping process is being performed, access to the file is prohibited from anywhere except the thread; and
wherein the thread periodically comparing the one or more first statuses to the one or more second statuses comprises periodically performing the mapping process.

20. A computer implemented method for communication between a user mode and a kernel mode, the method comprising using a thread to communicate data to a kernel driver, wherein a thread entry point is offset from a known address within a running process in dependence on a value of the data, such that determining a distance from the thread entry point to the known address is used to calculate the value of the data.

21. The computer implemented method of claim 20, wherein the thread is marked as THREAD_PRIORITY_TIME_CRITICAL priority, such that the thread is scheduled to run as soon as possible.

22-23. (canceled)
